(19) United States
(12) Patent Application Publication
(10) Pub. No.: US 2019/0066230 A1
(43) Pub. Date: Feb. 28, 2019

(54) PROVIDING DIGITAL FORUMS TO ENHANCE CIVIC ENGAGEMENT

(71) Applicant: Facebook, Inc., Menlo Park, CA (US)

(72) Inventor: Amod Ashok Dange, Mountain View, CA (US)

(21) Appl. No.: 15/686,657

(22) Filed: Aug. 25, 2017

(51) Int. Cl. G06Q 50/00; G06Q 30/02

(52) U.S. Cl. CPC G06Q 50/01; G06F 3/04817; G06Q 30/0205

(57) ABSTRACT

One or more embodiments of the present disclosure facilitate effective engagement in civic discussion between users of a networking system. In particular, systems and method described herein provide a communication platform over which users of a networking system can engage in civic discourse and provide feedback about various civic issues. For instance, systems and methods include configuring a digital forum for a jurisdiction (e.g., a legal jurisdiction) and provides one or more discussion interfaces within the digital forum within which users of the networking system can discuss civic issues including, for example, current laws, law proposals, representatives, candidates, and other topics associated with the jurisdiction.

### BACKGROUND

Recent years have seen rapid development in communication technology, particularly in the capabilities of computing systems that enable users to engage with or otherwise participate in civic issues. Indeed, conventional computing systems enable users to communicate with other users and engage in civil discourse in a variety of ways. For example, individuals can post political opinions on social media, send emails to representatives, and view live streams of town hall meetings and legislative sessions. Indeed, modern communication technologies enable users to communicate directly with representatives in addition to sharing content with large number of users.

Even as communication technology continues to improve, however, the ability of individuals to meaningfully engage in civil discourse has various limitations. For example, with the massive number of people having access to communication technology, many voices get lost in the billions of communications going back and forth between users. In addition, with the anonymity the Internet can provide, people are often flippant, rude, insincere, disingenuous, or otherwise uncivil in communicating about civic issues. Because of massive amounts of often uncivil messages going back and forth, well-informed and meaningful voices on important issues are often ignored or lost in the fray.

In addition, the current political structure also results in counterproductive discussion about important issues. For example, politics, party platforms, and biased media reports often monopolize public discourse at the expense of important civic issues that directly affect individuals. Indeed, the current political climate frequently results in high profile and often underqualified individuals having control over which civic issues are discussed and how those civic issues are resolved, even where those civic issues have a minimal impact on those high-profile individuals. As a result, many civic issues are discussed and decided upon based on a lack of information and a misrepresentation of the needs and interests of those people most affected by the various civic issues.

Moreover, current political discourse often requires that participants dedicate a substantial amount of time and money in order to have a meaningful voice. As an example, because town hall meetings and political forums often discuss a gamut of political issues, participants must often engage the entire gamut of political issues in order to have legitimacy among their peers to comment on issues that they care most about. Accordingly, current politics often require that any participant have a vested interest in all topics (or fit a particular party platform) in order to have their voice heard for any individual topic. Indeed, a constituent may desire to discuss a topic, but that topic may get pushed aside for more popular or controversial topics in which the loudest voices dominate the discussion. As a result, many individuals lose interest because they lack the money and time to become involved at a level in which their voice will be heard.

These and other problems exist with regard to facilitating effective engagement in civic dialog between users.

### BRIEF SUMMARY

One or more embodiments of the present disclosure provide benefits and/or solve one or more of the foregoing problems in the art with systems, methods, and computer-readable media that facilitate effective engagement in public discourse between co-users of a networking system. As will be described in further detail below, systems, methods, and computer readable media can improve civil discourse between users of a networking system by configuring a digital forum that allows users of the networking system to more effectively engage with other users about various civic issues. For example, one or more embodiments described herein facilitate proposing laws, amendments, and other initiatives, identifying users having a particular interest in the proposal(s), and providing a discussion interface within the digital forum that enables users to meaningfully engage and arrive at specific solutions about the various proposals.

As an example, in one or more embodiments, the disclosed systems, methods, and computer readable media configure a digital forum for a particular jurisdiction that allows users of the networking system to provide feedback on civic issues associated with the jurisdiction. One or more embodiments include identifying a proposed law and identifying (e.g., based on social networking data) users of a networking system having a predicted interest or expertise in the proposed law. The disclosed systems, methods, and computer readable media can further provide a discussion interface that enables users to provide feedback about the proposed law. In one or more embodiments, the disclosed systems, methods, and computer readable media monitor and aggregate the feedback to generate and provide a formalized proposal of the proposed law to users associated with the jurisdiction or any users of the networking system having a potential interest in the proposal.

Additional features and advantages of one or more embodiments of the present disclosure will be set forth in the description that follows, and in part will be obvious from the description, or may be learned by the practice of such example embodiments.

### BRIEF DESCRIPTION OF THE DRAWINGS

The detailed description is described with reference to the accompanying drawings in which:

FIG. 1 illustrates a block diagram of an environment in which a civic engagement system is implemented in accordance with one or more embodiments;

FIG. 2 illustrates an example graphical user interface including a listing of jurisdictions associated with digital forums provided by the civic engagement system in accordance with one or more embodiments;

FIGS. 3A-3B illustrate example graphical user interfaces including discussion interfaces for various laws in accordance with one or more embodiments;

FIGS. 4A-4B illustrate example graphical user interfaces including discussion interfaces for a proposed law in accordance with one or more embodiments;

FIG. 5 illustrates a schematic diagram of an example civic engagement system implemented on a server device(s) in accordance with one or more embodiments;

FIG. 6 illustrates a flowchart of a series of acts in a method for providing a group activity indicator in accordance with one or more embodiments;

FIG. 7 illustrates a block diagram of an example computing device in accordance with one or more embodiments;

FIG. 8 illustrates a block diagram of an example network environment of a social networking system in accordance with one or more embodiments; and

FIG. 9 illustrates a social graph in accordance with one or more embodiments.

### DETAILED DESCRIPTION

One or more embodiments of the present disclosure include a civic engagement system that facilitates effective engagement in civic dialog between users of a networking system (e.g., a social networking system). In particular, the civic engagement system provides a communication platform over which users of a networking system can engage in civic dialog and provide feedback about various civic issues. For instance, in one or more embodiments, the civic engagement system configures a digital forum for a jurisdiction (e.g., a legal jurisdiction) and provides one or more discussion interfaces within the digital forum within which users of the networking system can discuss civic issues including, for example, current laws, law proposals, representatives, candidates, and other topics associated with the jurisdiction.

As an example, in one or more embodiments, the civic engagement system enables users of the networking system to propose a law for a jurisdiction and initiate a discussion about the proposed law within a discussion interface. In one or more embodiments, the civic engagement system identifies users of the networking system having a predicted interest or expertise in the proposed law and provides the discussion interface to those identified users to enable the users to provide feedback with regard to the proposed law. The civic engagement system can further monitor and aggregate feedback (e.g., comments, ratings, proposed amendments, etc.) to generate a formalized law or proposal in view of the aggregated feedback. The civic engagement system can further provide the formalized law and, in one or more embodiments, facilitate further discussion about the formalized law.

As will be explained in further detail below, in facilitating civic discussion about various issues (e.g., law proposals), the civic engagement system can provide access to a legal repository including relevant information that enables users of the networking system to enhance discussion between users about the various issues. For example, in configuring a digital forum for a jurisdiction, the civic engagement system can link to relevant laws of the jurisdiction and provide access to source material from the legal repository to aid in the discussion. In one or more embodiments, the legal repository includes data about particular laws including legal histories, representatives who enacted and/or amended those laws, and other relevant data about laws referenced by the digital forum. In addition, in one or more embodiments, the legal repository includes plain language descriptions of various laws or proposals within respective discussion interfaces or digital forums. By providing access to the repository, the civic engagement system provides relevant information about a topic without requiring users of the networking group to independently navigate to third-party websites and/or perform extensive research to locate relevant information to contribute to the discussion.

In addition to generally providing access to a legal repository including a database of laws, the civic engagement system can further identify, from the legal repository, laws and associated information related to topics discussed within a digital forum. For example, where a user proposes a law (or any discussion topic), the civic engagement system can identify one or more laws or initiatives for other jurisdictions from the legal repository that have relevance to the proposed law. In addition, in one or more embodiments, the civic engagement system provides access to feedback for the related laws including, for example, user ratings and/or discussions conducted by other users of the networking system within corresponding discussion interfaces.

In one or more embodiments, the civic engagement system facilitates more effective and constructive discussions about various issues by causing ratings, comments, and other feedback from qualified users to surface within a digital forum. For example, the civic engagement system can identify one or more users from a particular discussion group having unique qualifications that enable them to materially add to a discussion about a particular issue. In one or more embodiments, the civic engagement system prioritizes feedback from those qualified users within a discussion interface to enhance the discussion with those comments that materially add to the discussion about the issue(s).

In one or more embodiments, the civic engagement system provides a platform whereby users of a networking system associated with a jurisdiction can effectively engage in civic discussion with other users of the networking system associated with the jurisdiction. In particular, the civic engagement system provides a digital forum for the jurisdiction that enables relevant users to the jurisdiction to discuss issues that uniquely affect the jurisdiction. In addition, in one or more embodiments, the civic engagement system provides limited access to the digital forums (e.g., based on social networking data) to non-relevant users of the networking system, thereby preventing sabotage of topic discussions from non-interested parties, lobbyists from unrelated jurisdictions, or other users of the networking system having a less genuine interest in the civic issues discussed via a given digital forum.

In one or more embodiments, the civic engagement system enables users to propose new laws and/or changes to existing laws. In addition, the civic engagement system generates and provides discussion interfaces that enable users of the networking system associated with the digital forum to rate, comment, or otherwise discuss various proposals. In one or more embodiments, the civic engagement system enables members of the digital forum to cooperatively edit, amend, or otherwise modify a proposed law to generate coherent and complete proposals to implement at an official level.

Features and functionality of the civic engagement system further connect and bridge gaps that exist between representatives and constituents across various jurisdiction levels. For example, the civic engagement system can provide access to a hierarchy of relevant jurisdictions for a given user of the networking system that enable the user to engage in civic discussions in both large jurisdictions (e.g., international, national) as well as small jurisdictions (e.g., school districts, cities). In addition, the civic engagement system aggregates and compiles feedback about any number of issues to generate formalized proposals that provide an accurate consensus of users for a particular jurisdiction.

In one or more embodiments, the civic engagement system facilitates cooperative participation by a community of users about civic issues across multiple levels of jurisdictions in an ad hoc manner. Even where users are not located at the same location (e.g., a town-hall meeting), users having a particular interest in a given jurisdiction can participate within a digital forum for the jurisdiction. Moreover, users can participate in discussion at multiple jurisdictional levels, including local jurisdictions (e.g., school district, cities) and large-scale jurisdictions (e.g., national, international) in a more meaningful way.

In addition, the civic engagement system enables users to more meaningfully engage with others on a per-topic basis. For example, because users often have limited interest in civic issues, and may care more about certain topics than other topics, the civic engagement system enable users to participate in discussion and collaboration on a per-topic basis within topical discussion interfaces. Accordingly, rather than requiring that a user become involved in all politics in order to have their voice heard on individual topics, the civic engagement system provides digital forums and discussion interfaces that allow users to specifically engage on topics in which they have a unique interest or expertise. In this way, the civic engagement system creates a flexible and customizable experience that allows users to engage about civic issues in an ad hoc manner as opposed to conventional politics, which often requires that people have a lot of money or dedicate a lot of time in order to have a voice.

In one or more embodiments, the civic engagement system enables a larger number of people to participate about civic issues. For example, by providing topic-specific discussion interfaces, users can participate in issues for which they have a unique interest or expertise, without requiring that those users sit through a town hall meeting in which a broad array of issues are discussed. In one or more embodiments, the civic engagement system identifies those users having a predicted interest in a topic and provides a notification that informs them of the discussion topic (e.g., a new proposal). The civic engagement system further provides access to a discussion interface in which the topic is being discussed. This enables users to conveniently patch in to a discussion thread and participate on the go (e.g., using a cell phone or other portable computing device), rather than attending lengthy meetings or limiting their participation in other ways. Providing convenient access and the ability to participate in topic-specific discussions fosters increased participation across all kinds of issues resulting in better developed proposals across a greater array of topics (e.g., rather than just hot-button political topics).

In one or more embodiments, the civic engagement system enables users to contribute to the legal repository in an ad hoc manner. For example, the civic engagement system maintains a record of changes made to various laws, definitions, representatives, jurisdictions, etc. and enables users to view the record of changes. In addition, the civic engagement system provides digital forums and discussion interfaces that enable discrete groups of users to collectively update or otherwise modify data stored on the legal repository by providing feedback in connection with proposals and various topics. As will be described in further detail below, in one or more embodiments, the civic engagement system maintains records of the modifications using various formats (e.g., block chains) that enable users to view modification histories and provides a flexible mechanism for users to contribute to the legal repository in an ad hoc manner.

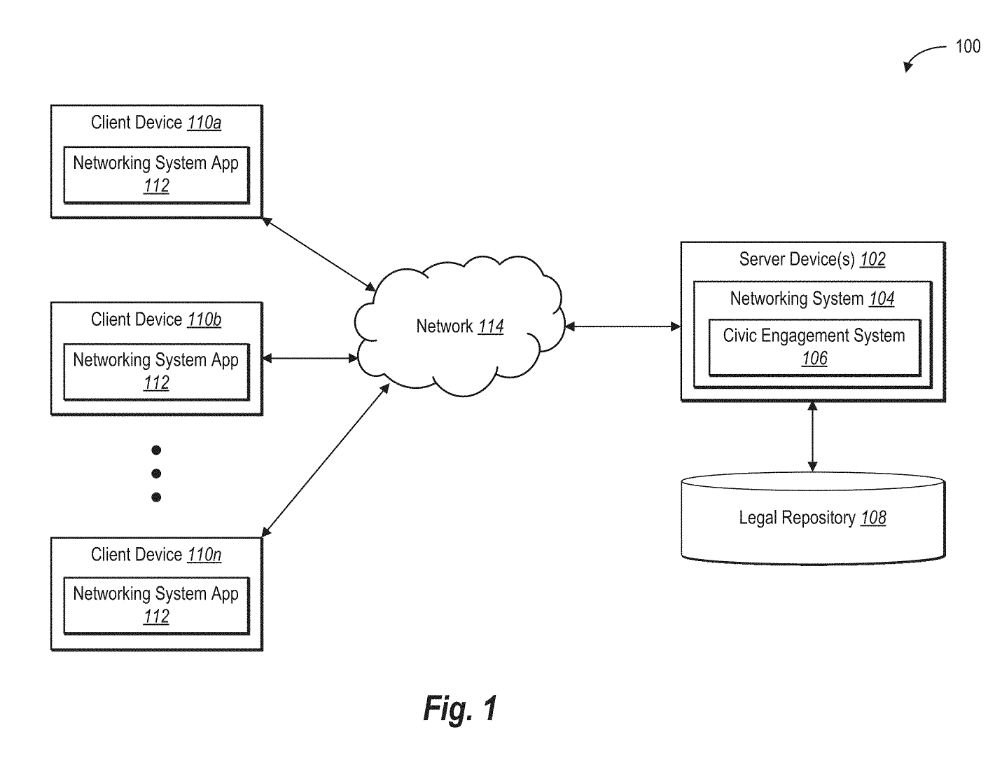

Additional detail will now be provided regarding the civic engagement system in relation to illustrative figures portraying exemplary embodiments. For example, FIG. 1 illustrates a block diagram of an example communication environment 100 for providing a civic engagement platform for users of a networking system. As illustrated in FIG. 1, the communication environment includes a server device(s) 102 including a networking system 104, which includes a civic engagement system 106. As further shown, the communication environment 100 includes a legal repository 108. The communication environment 100 also includes client devices 110a-n that include networking system applications 112. While the civic engagement system 106 is shown within the networking system 104 on the server device(s) 102, the networking system applications 112 can provide one or more features discussed herein with regard to the civic engagement system 106. Nonetheless, for the sake of explanation, one or more embodiments described herein describe the acts and steps being performed by the civic engagement system 106 implemented on the server device(s) 102.

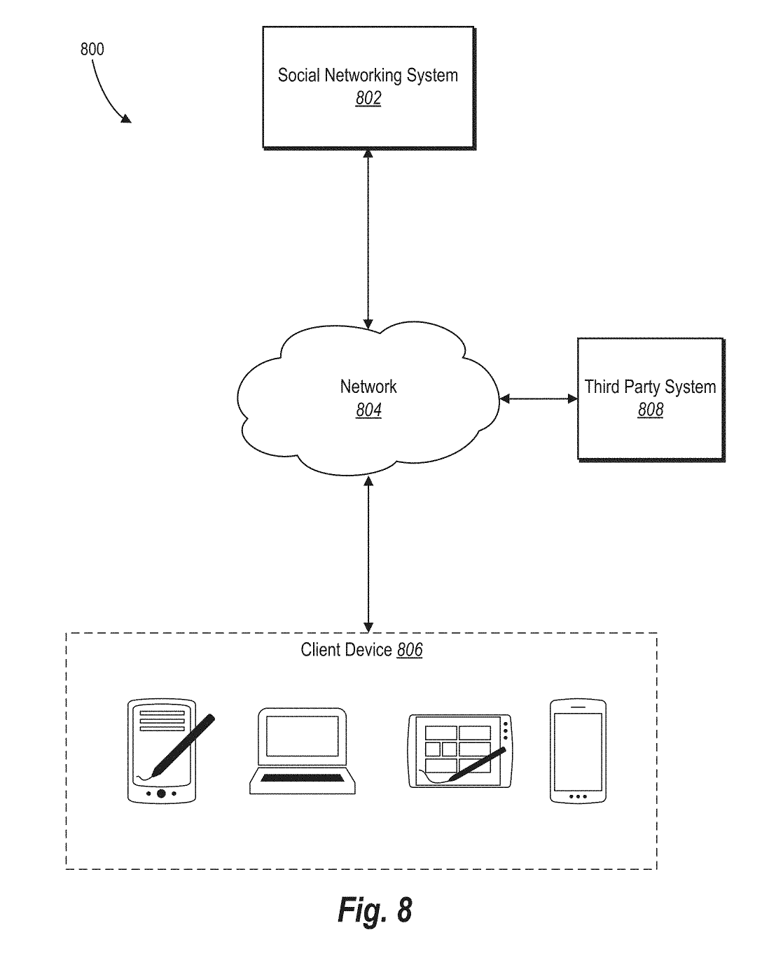

As shown in FIG. 1, each of the server device(s) 102, client devices 110a-n, and legal repository 108 can communicate over a network 114. The network 114 may include one or multiple networks and may use one or more communication platforms or technologies suitable for transmitting data. In one or more embodiments, the network 114 includes the Internet or World Wide Web. In addition, or as an alternative, the network 114 can include various other types of networks that use various communication technologies and protocols. Additional details relating to the network 114 are explained below in reference to FIG. 8.

Although FIG. 1 illustrates a particular number and arrangement of client devices 110a-n, server device(s) 102, and legal repository 108, it will be understood that the communication environment 100 can include any number of devices, including any number of server devices 102, client devices 110a-n, and legal repositories 108. In addition, in one or more embodiments, the legal repository 108 refers to a combination of storage space implemented on the server device(s) 102 and one or more storage spaces implemented on one or more third-party servers. Moreover, one or more of the devices may directly communicate with the server device(s) 102 or via an alternative communication network, bypassing the network 114.

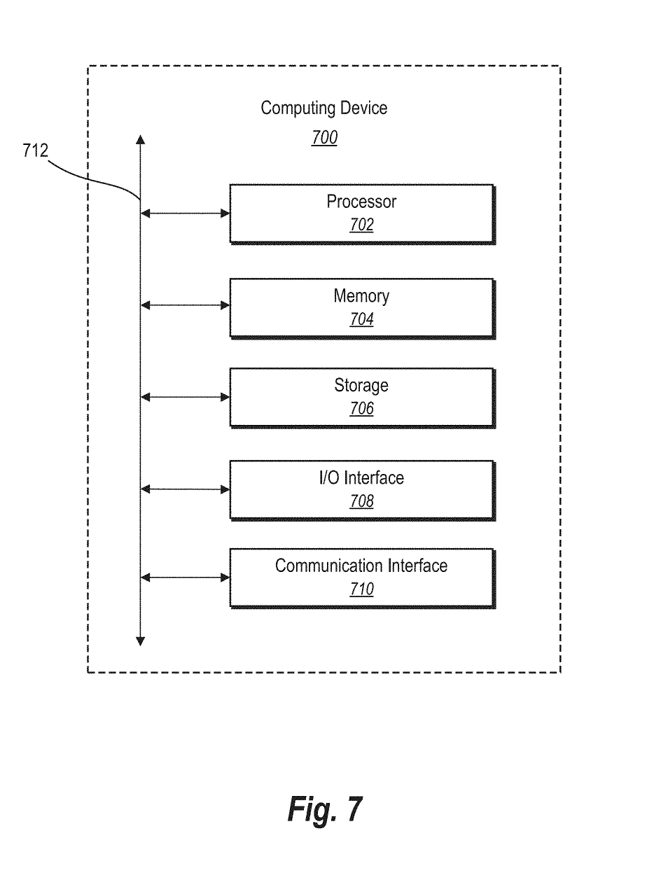

In addition, the client devices 110a-n may refer to various types of computing devices. For example, one or more of the devices may include a mobile device such as a mobile telephone, a smartphone, a PDA, a tablet, or a laptop. Additionally, or alternatively, one or more of the devices may include a non-mobile device such as a desktop computer, a server, or another type of computing device. Additional detail with regard to different types of computing devices is described in reference to FIG. 7.

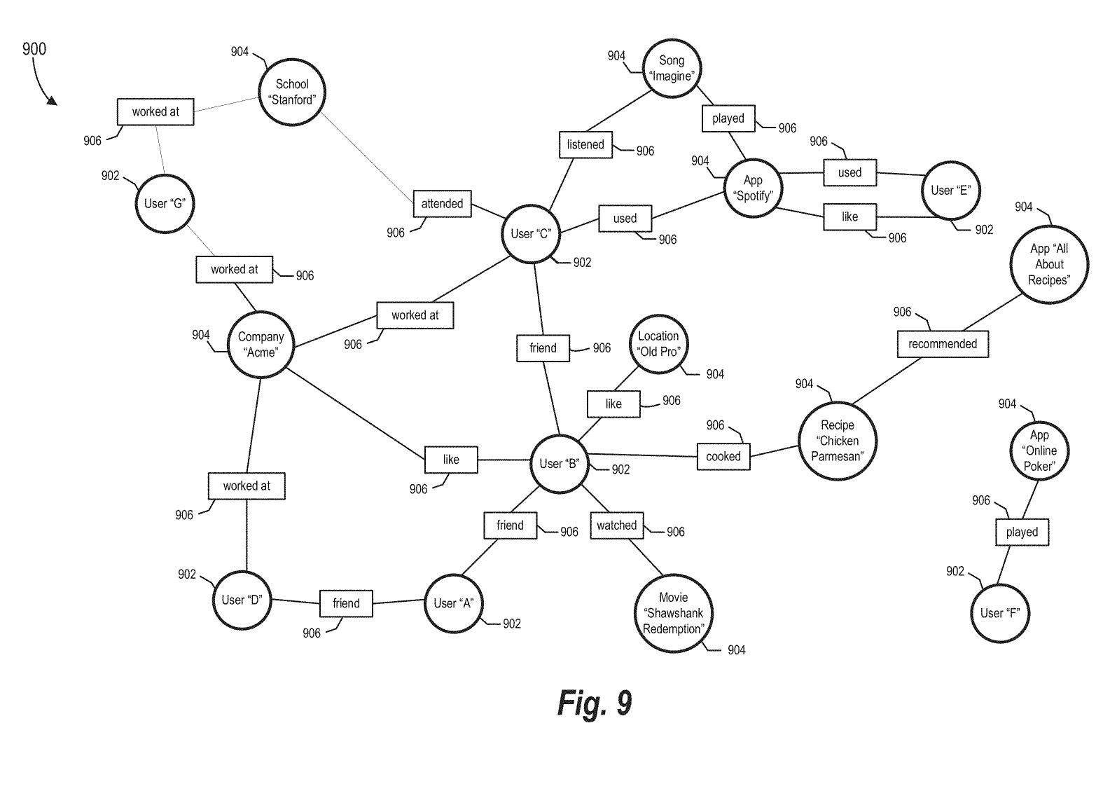

The networking system 104 can refer to various types of networking systems including, for example, a social networking system, an electronic messaging system, or other type of networking system over which a community of users and co-users can share and access digital content. As such, while one or more examples described herein refer specifically to a social networking system, it will be understood that features and functionality described in connection with a social networking system can similarly apply to other types of networking systems. Additional detail with regard to the networking system 104, and particularly an example social networking system, is described below in connection with FIGS. 8-9.

In addition, as shown in FIG. 1, each of the client devices 110a-n include a networking system application 112. In one or more embodiments, the networking system application 110 (e.g., a social networking system application and/or electronic messaging application) refers to a software application associated with the networking system 104. In one or more embodiments, the networking system application 112 enables users of the networking system 104 to interact with other users of the networking system 104. In one or more embodiments, the networking system application 112 refers to a native or hybrid application installed on a respective computing device. Alternatively, in one or more embodiments, the networking system application 112 refers to a web browser used to access the networking system 104 (e.g., a website associated with the networking system 104 provided via a web browser on a respective computing device).

As will be described in further detail below, the communication environment 100 enables users of the networking system 104 to communicate and engage in civic issues within digital forums associated with respective jurisdictions. For example, in one or more embodiments, the civic engagement system 106 configures digital forums for corresponding jurisdictions and provides, within the digital forums, discussion interfaces associated with various topics that enable users of the networking system 104 having an interest in the various topics to engage via the discussion interfaces. In one or more embodiments, the civic engagement system 106 enables users to propose new laws, changes to existing laws, or other initiatives and facilitates a cooperative effort of users to collaborate and cooperatively create formal proposals associated with various topics.

In addition, as will be described in further detail below, the civic engagement system 106 maintains a legal repository 108 that includes information related to laws, representatives, proposed laws, and other topics discussed within the digital forums. For example, in one or more embodiments, the legal repository 108 includes a database of current laws, definitions, representatives, and other information associated with the jurisdiction (e.g., dates of passed laws, amendment histories, elections). In addition, in one or more embodiments, the legal repository 108 includes proposed laws and associated ratings, scores, comments, and a history of modifications to the proposed laws leading up to formalization of the proposed laws. Further, in one or more embodiments, the legal repository 108 includes definitions, linked articles, and other useful information to provide to users of the networking system 104 in connection with respective discussion interfaces and/or digital forums.

As will be described in further detail below, one or more embodiments of the legal repository 108 includes histories of laws and proposals described herein. For example, in one or more embodiments, the civic engagement system 106 constructs block chains including a history of changes to a given law, definitions, jurisdiction boundaries, or other blocks of information stored within the legal repository 108. In one or more embodiments, the civic engagement system 106 stores received proposals, user feedback, and various amendments within the legal repository within block chains on the legal repository 108.

In one or more embodiments, the civic engagement system 106 dynamically updates information contained within the legal repository 108. For example, in one or more embodiments, the civic engagement system 106 adds new information in response to receiving new proposals, formalized proposals, detecting law changes, new elections, etc. In addition, as comments, ratings, scores, and various user feedback indicates changing demographics, opinions, or understanding associated with various topics, the civic engagement system 106 can additionally update definitions, proposals, ratings, etc. based on the received, detected, or otherwise obtained user feedback in connection with various topics. In one or more embodiments, the civic engagement system 106 stores updates via block chains maintained on the legal repository 108.

As used herein, a “user” of the networking system 104 refers to any user or other entity having access to one or more digital forums hosted by the networking system 104. For example, a user can refer to any entity having an account and/or profile registered with the networking system 104 and which enables the user to communicate with other users of the networking system 104. In one or more embodiments, the networking system 104 maintains a user profile including information used by the networking system 104 to determine one or more jurisdictions associated with the user.

As used herein, a “jurisdiction” refers to a legal jurisdiction or defined community. For example, a jurisdiction can refer to a national jurisdiction including all users associated with a given country. By way of example and not limitation, jurisdictions may include international, national, state, district, county, city, school district, or other discrete communities. In one or more embodiments, a user belongs to multiple jurisdictions. For example, a user may belong to a hierarchy of multiple jurisdictions including a city located within a state, which is located within a country where the city, state, and country each refer to different jurisdictions.

As mentioned above, civic engagement system 106 can host digital forums associated with corresponding jurisdictions. As used herein, a “digital forum” refers to a digital medium or virtual space for sharing communications, digital content, and otherwise interacting between members of the digital forum (e.g., users of the networking system 104 to which the civic engagement system 106 has granted access). For example, a digital forum can refer to a web page, social networking group space, or messaging forum hosted by the networking system 104. In addition, the civic engagement system 106 can manage access to digital forums for different jurisdictions by selectively providing access to users of the networking system 104 associated with corresponding jurisdictions. Moreover, in one or more embodiments, the civic engagement system 106 manages access to individual discussion interfaces within a given digital forum.

As used herein, a “discussion interface” refers to a discrete interface within a digital forum within which users of the digital forum can communicate. For example, in one or more embodiments, a discussion interface refers to a post by a user of the digital forum including a message and/or digital content shared with other users of the digital forum. In addition to the post, the discussion interface can include user ratings (e.g., likes, reactions) in addition to comments or digital content shared in response to the original post. As an alternative to a user post, a discussion interface can include text of a law, proposal, amendment, or other topic including user ratings and comments or digital content shared within the interface. As will be described in further detail below, a digital forum can include any number of discussion interfaces.

As used herein, a “proposed law” or “proposal” refers to a proposed topic within a digital forum by a user or the networking system 104. In particular, in one or more embodiments, a proposed law refers to a proposed new law, an amendment to an existing law, a definition for a word, a modification to an existing definition, or other topic related to a jurisdiction for prompting a conversation with other users associated with a given digital forum. As will be discussed in further detail below, the civic engagement system 106 can monitor and aggregate feedback and generate a formalized proposal based on an original proposal or proposed law. As used herein, a “formalized proposal” refers to a modified version of a proposed law based on user feedback received within a discussion interface associated with the proposed law. A formalized proposal can include a final version of a proposed law in addition to any incremental changes or amendments leading up to the formal proposal.

In one or more embodiments, the civic engagement system 106 utilizes a legal repository to provide information to users of the networking system 104 within digital forums and individual discussion interfaces. As used herein, a “legal repository” or “repository” refer interchangeably to a storage space or database including information associated with various jurisdictions. For example, the legal repository can include information about laws, representatives, elections, proposals and other initiatives, and other information associated with a given jurisdiction. In addition, in one or more embodiments, the legal repository includes supplemental information about various civic topics including various statistics, definitions of various terms, and other information that would aid in discussion of associated topics. As mentioned above, and as will be discussed in further detail below, the legal repository can include a repository maintained on centralized database or multiple remote third-party databases (e.g., servers) in communication with the server device(s) 102.

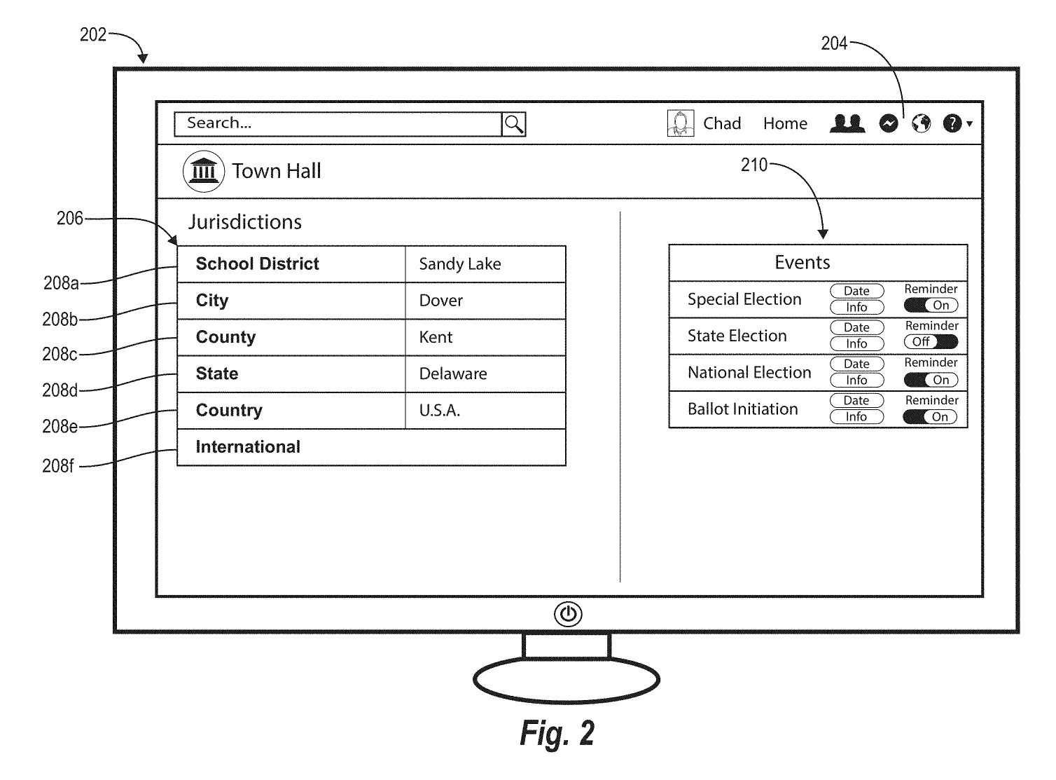

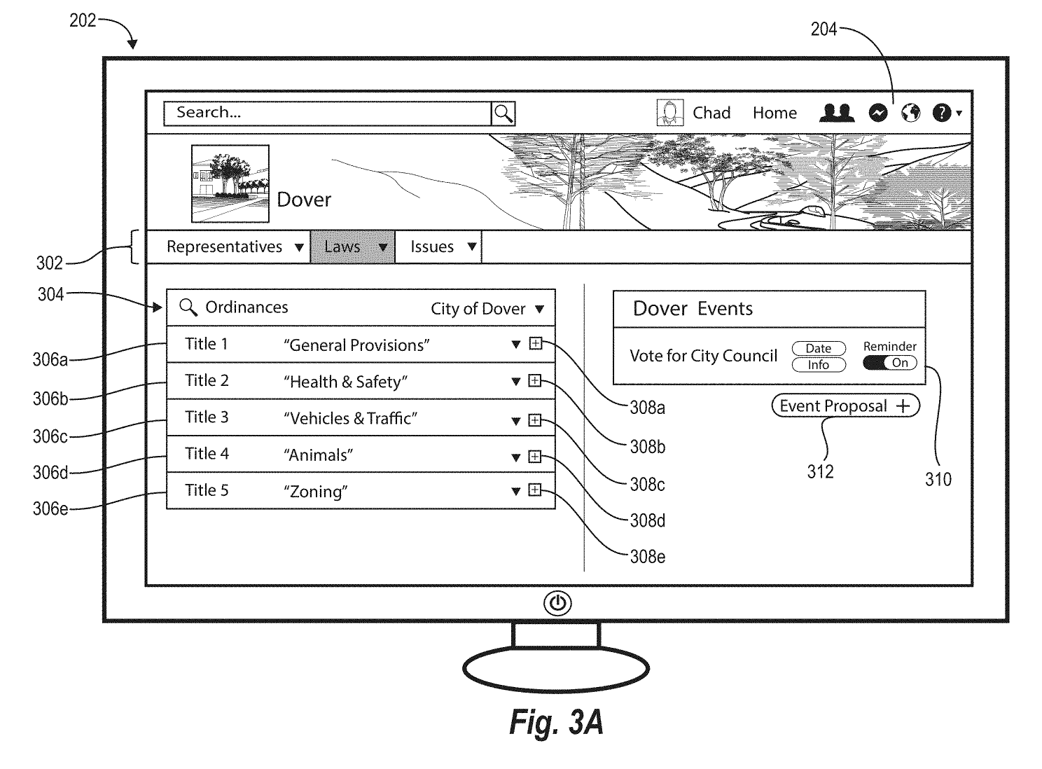

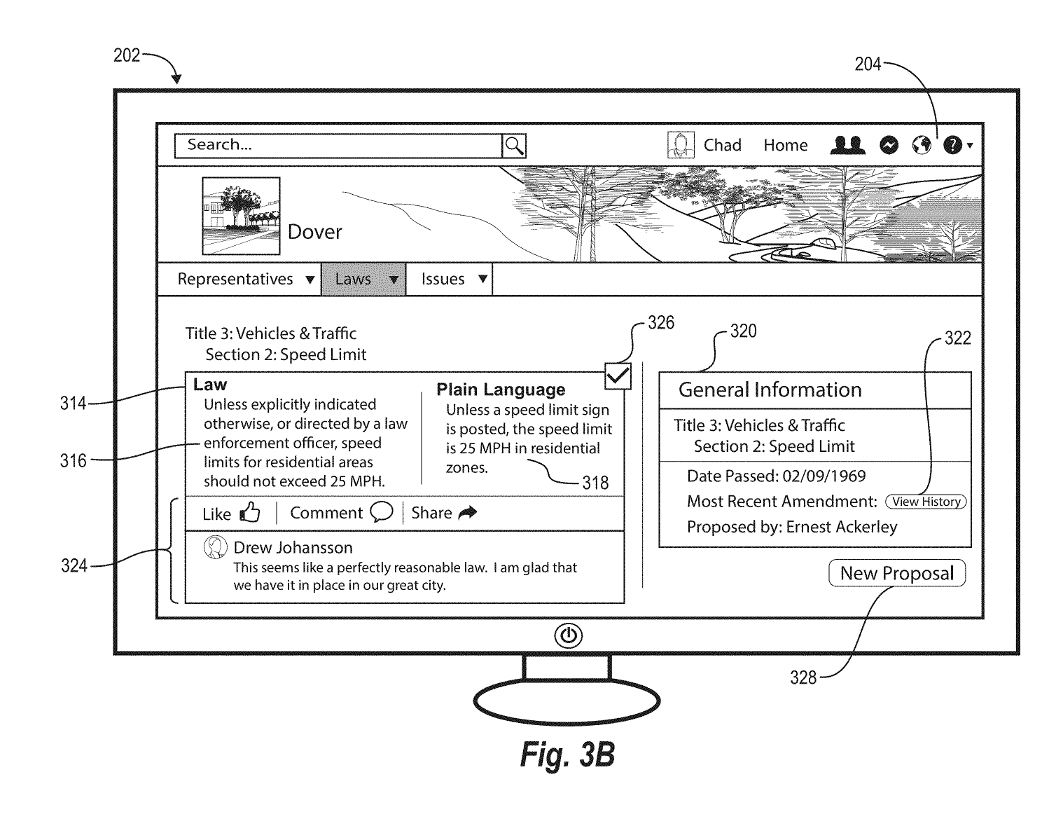

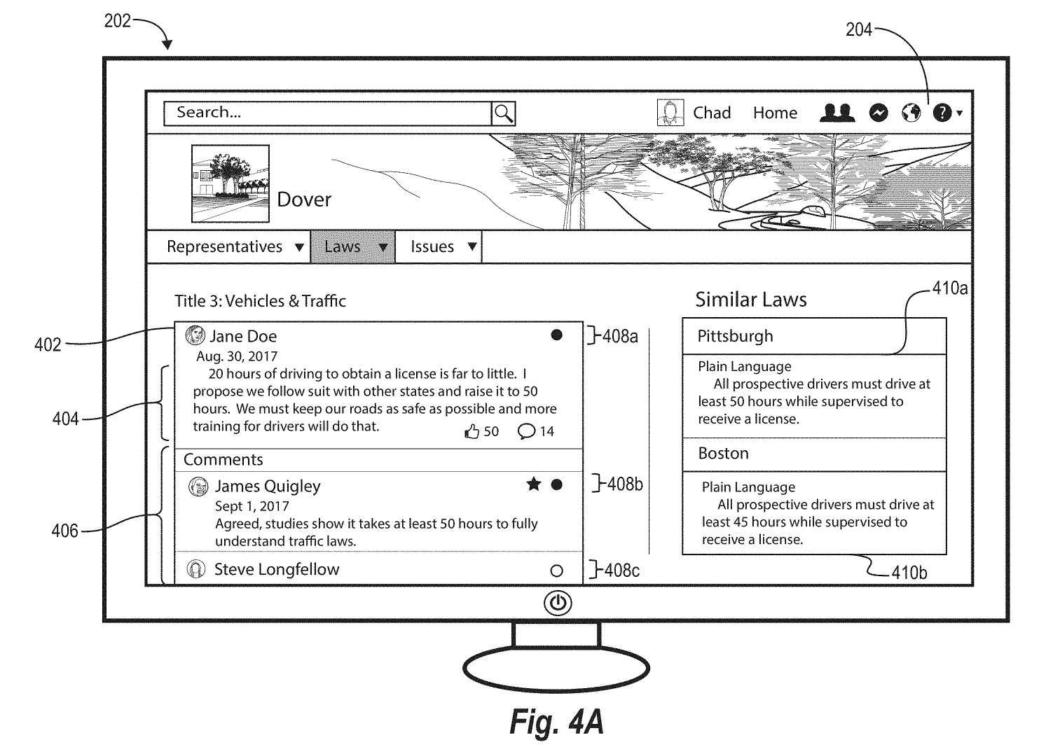

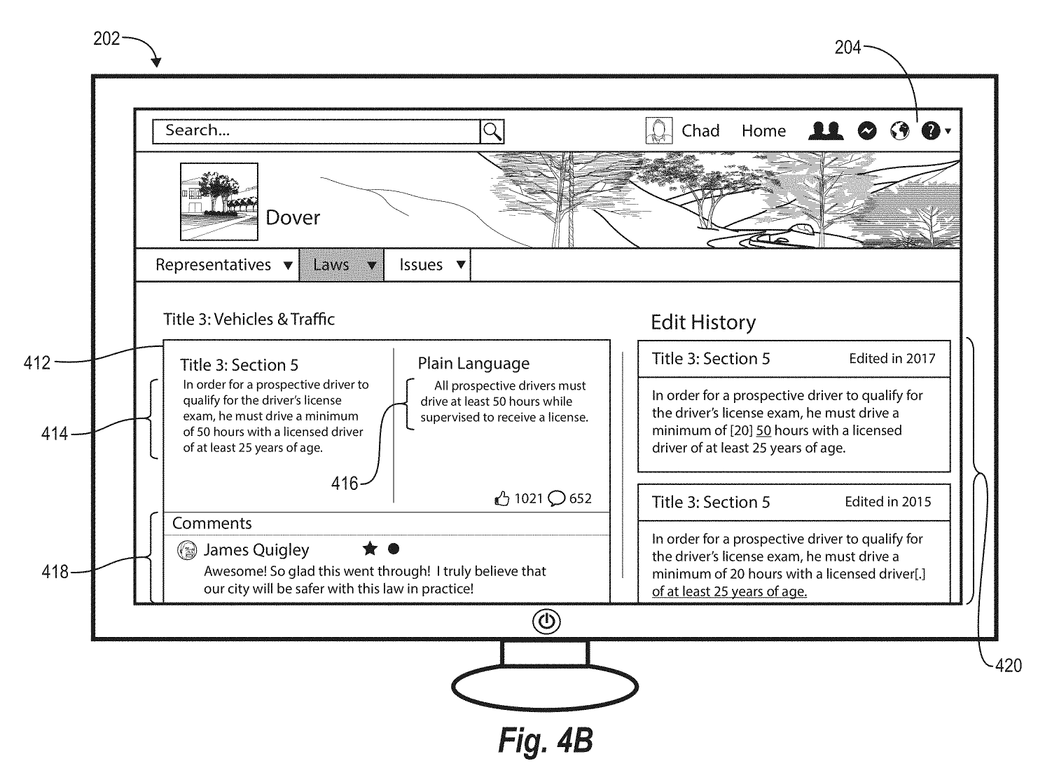

Additional features with regard to implementing digital forums will be described by way of example in connection with exemplary graphical user interfaces shown in FIGS. 2-4B. In particular, FIGS. 2-4B illustrate a client device 202 having a graphical user interface 204 that includes example digital forums in accordance with one or more embodiments described herein. For example, FIG. 2 illustrates an example graphical user interface 204 including a display of a hierarchy of jurisdictions applicable to a user of the client device 202. In particular, FIG. 2 illustrates an example landing page for a plurality of digital forums corresponding to jurisdictions associated with a user of the client device 202. In addition, FIGS. 3A-3B illustrate an example graphical user interface 204 including a digital forum for a selected jurisdiction including discussion interfaces that facilitate discussion about one or more current laws or ordinances of the selected jurisdiction. Moreover, FIGS. 4A-4B illustrate an example graphical user interface 204 including features and functionality of the civic engagement system 106 for proposing a law and aggregating received feedback for generating and formal proposal based on the proposed law.

As shown in FIG. 2, the graphical user interface 204 includes a menu 206 of jurisdiction icons 208a-f corresponding to jurisdictions associated with a user of the client device 202. For instance, in the example shown in FIG. 2, the civic engagement system 106 provides the menu 206 of jurisdiction icons 208a-f including selectable options corresponding to a school district (Sandy Lake), a city (Dover), a county (Kent), a state (Delaware), country (U.S.A.), and an international jurisdiction. In one or more embodiments, each of the jurisdiction icons 208a-f correspond to a digital forum for an associated jurisdiction. For example, in response to selecting the city jurisdiction icon 208b, the civic engagement system 106 would provide an interface for a digital forum corresponding to Dover City.

In one or more embodiments, the civic engagement system 106 determines jurisdictions associated with a user of the client device 202 based on various types of information. For example, in one or more embodiments, the civic engagement system 106 identifies an address for the user (e.g., based on a user profile) and identifies all jurisdictions associated directly with the identified address. Alternatively, in one or more embodiments, the civic engagement system 106 can determine one or more jurisdictions based on birth information, a listed place of employment, or a history of social networking interactions that reference or otherwise identify a location associated with one or more jurisdictions. Furthermore, in one or more embodiments, the civic engagement system 106 determines the relevant jurisdictions for a user based on information stored in one or more nodes of a social graph that are associated with the user.

As shown in FIG. 2, the menu 206 includes corresponding jurisdiction icons 208a-f for each jurisdiction level. In particular, the menu 206 includes a single jurisdiction icon corresponding to each jurisdiction level (school district, city, county, etc.). Alternatively, in one or more embodiments (e.g., where more than one jurisdiction may apply to a given user), the civic engagement system 106 identifies multiple jurisdictions for a corresponding jurisdiction level. For example, where a user indicates that they live in a first state and work in another state, the civic engagement system 106 may provide jurisdiction icons corresponding to both the first state and the second state (and/or corresponding cities, counties, etc.), thereby providing access to digital forums for each of the first state and second state.

As an alternative to identifying jurisdictions based on profile data or other social networking information, in one or more embodiments, the civic engagement system 106 additionally enables a user to select one or more jurisdictions. For example, where a user has dual citizenship, a family member in another jurisdiction, or other circumstance that prompts a unique interest in multiple jurisdictions, the user can select one or more additional jurisdictions to add to the menu 206. The civic engagement system 106 can therefore provide any number of jurisdiction icons within the menu, providing access to any number of jurisdictions associated with the user.

As further shown in FIG. 2, the graphical user interface 204 includes an events menu 210 including one or more events associated with jurisdictions that are relevant to the user of the client device 202. For example, as shown in FIG. 2, the events menu 210 shows events including a special election, a state election, a national election, and a ballot initiative. As further shown, the events menu 210 includes one or more selectable options to view a date or other information about a corresponding event. In one or more embodiments, the events menu 210 further includes a reminder option that causes the civic engagement system 106 to send one or more reminders to a user of the client device 202 (e.g., via a networking system 104 communication, text message, or other communication platform).

Similar to the jurisdiction icons 208a-f, in one or more embodiments, each of the events within the events menu 210 correspond to an associated digital forum. For example, in one or more embodiments, the events menu 210 includes selectable events that, when selected, cause the civic engagement system 106 to provide a discussion interface for a corresponding jurisdiction via the graphical user interface 204. Accordingly, as an example, in response to detecting a user selection of the state election event, the civic engagement system 106 can provide a digital forum for Delaware including one or more discussion interfaces associated with the state election. Alternatively, in one or more embodiments, the civic engagement system 106 can configure and provide a digital forum exclusively for the selected event). Similar to determining relevant jurisdictions, the civic engagement system 106 determines relevant events for a user based on profile information or information stored in one or more nodes of a social graph.

As mentioned above, in response to detecting a user selection of a jurisdiction icon, the civic engagement system 106 can provide a digital forum for the jurisdiction corresponding to the selected icon. For example, as shown in FIG. 3A, in response to a user selecting the Dover city icon 208b, the civic engagement system 106 can provide a digital forum for Dover city via the graphical user interface 204 of the client device 202. In particular, FIG. 3A shows an example digital forum including various menus and selectable topics for discussion with other users of the shown jurisdiction.

As shown in FIG. 3A, the digital forum includes a forum header 302 including categories of topics for discussion. For example, the forum header 302 includes selectable options for topics about representatives of the city, laws, and other issues. Based on a selection of one of the selectable options of the forum header 302, the civic engagement system 106 can provide a corresponding menu including any number of selectable options associated with the selected option of the forum header 302.

For example, as shown in FIG. 3A, the civic engagement system 106 provides a menu 304 including topic icons 306a-e corresponding to current laws and ordinances of the jurisdiction. In particular, the topic icons 306a-e include titles for corresponding ordinances of the City of Dover including “General Provisions,” “Health & Safety,” “Vehicles & Traffic,” “Animals,” and “Zoning.” In one or more embodiments, each of the topic icons 306a-e can be expanded to show more detailed sections of each title. For example, the menu 304 can include topic icons for any number of titles in addition to more granular sections within a given title (e.g., when one of the title icons are expanded to show more granular sections or subsections).

As will be discussed in further detail in connection with FIG. 3B, the civic engagement system 106 can manage a discussion interface associated with each of the listed topics. For example, in one or more embodiments, the digital forum includes a discussion interface associated with each of the titles corresponding to the topic icons 306a-e. In addition, the digital forum can include a discussion interface for each section, subsection, or discrete portion of the corresponding title(s). For example, where the “Vehicles & Traffic” title includes discrete sections or subsections for “licenses” and/or “speed limits,” the civic engagement system 106 can provide a first discussion interface for the general “Vehicles & Traffic” title in addition to individual discussion interfaces for respective “licenses” and “speed limits” sections.

As further shown, the digital forum includes add proposal icons 308a-e displayed in conjunction with each of the topic icons 306a-e. In one or more embodiments, a user of the client device 202 can propose a new law or change to an existing law by selecting one of the proposal icons 308a-e. For example, in response to detecting a user selection of a proposal icon, the civic engagement system 106 can initiate a discussion interface within which the user of the client device 202 proposes a new law, an amendment to an existing law, or simply a proposed topic of conversation within the digital forum (e.g., related to the selected topic). Additional detail in connection with proposing a new law is discussed in further detail in connection with FIGS. 4A-4B.

Similar to the graphical user interface 204 discussed in FIG. 2, the digital forum shown in FIG. 3A additionally includes an events menu 310 including events specific to the selected jurisdiction. For example, the events menu 310 includes events specific to the city of Dover including a vote for city council. Similar to the events menu 210 including events from multiple jurisdictions, the events menu 310 shown in FIG. 3A includes one or more selectable options to view a date or other information about the event(s). In addition, each event within the events menu 310 includes a reminder option that, if selected, causes the civic engagement system 106 to send one or more reminders to the user of the client device 202.

As further shown, the digital forum includes an event proposal icon 312 that enables a user to propose a new event for the jurisdiction. For example, where a community event is taking place, a user may propose the new event, causing a new event to appear within the event menu 310. In one or more embodiments, rather than simply adding a new event to the events menu 310, the civic engagement system 106 can generate a discussion interface that enables one or more additional users discuss the event and/or verify the event prior to adding the event to the event menu 310. Accordingly, in one or more embodiments, the civic engagement system 106 prevents users from unilaterally adding events by implementing an approval and/or vetting process similar to processes for formalizing proposed laws, as discussed in further detail below.

As mentioned above, each of the laws including titles and respective sections/sub-sections may have corresponding discussion interfaces provided within the digital forum. FIG. 3B illustrates an example discussion interface for a selected law. In particular, FIG. 3B illustrates a discussion interface for a section within the “Vehicles & Traffic” title shown within the topics menu 304 of FIG. 3A. For example, in response to detecting a user selection of the “Vehicles & Traffic” topic icon 306c, the civic engagement system 106 provides discussion interfaces for multiple sections within the Vehicles & Traffic title.

To illustrate, FIG. 3B shows a graphical user interface 302 including a specific section of the selected title (Vehicles & Traffic) from FIG. 3A. In particular, in response to detecting a user selection of the Vehicles and Traffic title icon 306c, the civic engagement system 106 provides the discussion interface 314 associated with the selected section. In one or more embodiments, the civic engagement system 106 provides multiple discussion interfaces for respective sections within the selected title.

As shown in FIG. 3B, the discussion interface 314 includes source text 316 of the selected law (section). In addition, the discussion interface 314 includes a plain text description 318 of the selected law. In one or more embodiments, the civic engagement system 106 identifies the source text 316 and plain text description 318 from the legal repository 108. In one or more embodiments, the digital forum further includes additional information 320 about the selected law. For example, as shown in FIG. 3B, the civic engagement system 106 provides a block of additional information 320 including a referenced title and section, a date the section was passed, a history of amendments, and one or more representatives who proposed the law and/or amendment(s). As further shown, the additional information 320 includes a view history option 322 that enables a user to view a history of changes/amendments to the selected law. In one or more embodiments, the civic engagement system 106 further provides previously received proposals made by users of the digital forum in connection with the selected law.

In addition to the source text 316 and plain text description 318, the discussion interface 314 further includes feedback 324 from various users of the networking system 104. For example, as shown in FIG. 3B, the feedback 324 includes ratings, comments, and other feedback provided by users of the networking system 104 having access to the discussion interface 314. In one or more embodiments, the civic engagement system 106 provides an aggregate rating 326 for the law based on the received feedback 324 within the discussion interface. For instance, as shown in FIG. 3B, the selected section has a “positive” aggregate rating 326 based on a determination that a threshold number or percentage of users have provided positive feedback in reference to the identified law (e.g., within the discussion interface 314). Alternatively, in one or more embodiments, the civic engagement system 106 provides an indication of a score or other metric associated with an aggregate opinion of users of the digital forum with respect to the identified law.

In one or more embodiments, the civic engagement system 106 determines a score for a law, proposal, definition, or other topic of a discussion interface by prioritizing feedback of various users of the networking system 104. For example, in one or more embodiments, the civic engagement system 106 applies a higher weight to feedback from users that live within a geographic boundary of the jurisdiction associated with the digital forum. In addition, in one or more embodiments, the civic engagement system 106 applies a higher weight to feedback from users that have a high general reputation score and/or high reputation score in connection with a topic corresponding to the proposal. Additional detail with regard to determining a reputation score for a user is provided below.

In one or more embodiments, the civic engagement system 106 further enables users to provide ratings for a jurisdiction as a whole. For example, the civic engagement system 106 can generate a score for a jurisdiction by aggregating scores for individual laws, representatives, and other topics unique to the jurisdiction. Accordingly, in addition to providing a rating 326 for a specific law or proposal, the civic engagement system 106 provides a mechanism that allows users to view and/or contribute to overall ratings for entire jurisdictions.

As further shown in FIG. 3B, the digital forum includes a new proposal icon 328 in connection with the selected law. In one or more embodiments, a user of the client device 202 can select the new proposal icon 328. In response, the civic engagement system 106 provides an interface for composing a new law or amendment to the selected law. For example, in one or more embodiments, the civic engagement system 106 generates a discussion interface that enables other users associated with the digital forum to rate, comment, or otherwise provide feedback within the discussion interface. In one or more embodiments, the civic engagement system 106 facilitates discussion among users associated with the digital forum to reject, modify, approve, or otherwise generate a formalized proposal of the proposed law.

FIGS. 4A-4B illustrate an example proposal of a new law in accordance with one or more embodiments described herein. In particular, FIGS. 4A-4B illustrate a client device 202 including a graphical user interface 204 for presenting a digital forum and discussion interfaces. More specifically, as shown in FIG. 4A, the digital forum includes a new proposal interface 402 including a posted comment 404 and associated feedback 406. As shown in FIG. 4A, the new proposal interface 402 includes an identification of a user of the digital forum (Jane Doe) who composed and shared the comment 404. In addition, the new proposal discussion interface 402 includes text of the comment 404 and feedback 406 including ratings and comments received in response to the posted comment 404.

As mentioned above, and as shown in FIG. 4A, the new proposal interface 402 includes a posted comment 404 including text of a comment composed by a user (Jane Doe) of the digital forum. In one or more embodiments, the civic engagement system 106 determines that the comment includes a proposal for a new law or amendment to existing law. For example, based on a user selection of a new proposal, the civic engagement system 106 can determine that a comment includes a proposal in connection with the selected law. Alternatively, in one or more embodiments, the civic engagement system 106 analyzes the text of the posted comment 404 to identify a proposal for a new law or amendment to an existing law. In one or more embodiments, the civic engagement system 106 utilizes natural language processing, machine learning, or other analysis technique to identify a proposed idea or amendment.

In particular, with regard to the posted comment 404, the civic engagement system 106 determines that the text of the proposal includes a proposed idea to modify an existing law for a minimum number of hours that a prospective driver must drive prior to qualifying to receive a driver's license. In response, the civic engagement system 106 can provide the new proposal interface 402 in connection with one or more existing laws that the posted comment 404 proposes to amend.

In one or more embodiments, the civic engagement system 106 provides the new proposal interface 402 within the digital forum upon determining that the user posting the comment 404 is authorized to post a new proposal within the digital forum for the associated jurisdiction. For example, in one or more embodiments, the civic engagement system 106 limits users having access to share new proposals to members of the digital forum (e.g., users associated with a corresponding jurisdiction). In addition, in one or more embodiments, the civic engagement system 106 enables only users having a threshold reputation score based on previous interactions with other users within the digital forum and/or based on positive feedback received within various discussion interfaces within the digital forum.

In one or more embodiments, the civic engagement system 106 further provides one or more reputation indicators 408a-c to indicate a reputation of the user who posts the comment 404 and users who provide the feedback 406. For example, as shown in FIG. 4A, the civic engagement system 106 provides a first reputation indicator 408a (e.g., a solid dot) to indicate that the user (Jane Doe) posting the original comment 404 is from (e.g., has an address within) the jurisdiction associated with the relevant digital forum. As further shown, a first commenting user (James Quigley) includes multiple reputation indicators 408b (e.g., a star and a solid dot) indicating that the first commenting user is from the relevant jurisdiction (as indicated by the dot) and has been tagged as an “expert” for the topic being discussed within the posted comment 404. As further shown, a second commenting user (Steve Longfellow) includes a reputation indicator 408c (a blank dot) indicating that the second commenting user is not from the relevant jurisdiction and not a tagged “expert” on the topic being discussion.

The civic engagement system 106 can indicate various types of reputations of the original poster and any commenters. For example, as indicated above, the civic engagement system 106 can provide a solid dot (or another indicator) associated with whether a respective user is from the jurisdiction associated with the digital forum. As another example, the civic engagement system 106 can provide a star (or other indicator) associated with whether the civic engagement system 106 has identified the user as an “expert” for a given topic. The civic engagement system 106 can further provide other types of indicators to indicate various types of reputations associated with corresponding users. For example, the civic engagement system 106 can provide various types of indicators associated with new users, users having a low reputation for a given topic, or users having a relationship to a user viewing a given discussion forum.

In addition to generally identifying one or more users as experts, residents, or other classification, the civic engagement system 106 can further determine a reputation score for users of the networking system 104. For example, in one or more embodiments, the civic engagement system 106 generates a reputation profile including a general reputation score and/or reputation scores for respective topics. The civic engagement system 106 can determine a general reputation score based on various factors including, for example, civility with other users of the networking system 104, a history of posting about civic issues, a history of positive ratings from other users with respect to various comments or proposals, whether proposals by the user are eventually adopted etc.

In addition to the general reputation score, the civic engagement system 106 can further determine individual reputation scores for respective civic topics. In particular, the civic engagement system 106 can determine reputation scores for individual topics based on various factors including, for example, field of education, profession, and a history of social networking posts including feedback by other users with respect to the history of social networking posts. It will be understood that a user may have a high reputation score with respect to a specific topic with a low or non-existent reputation score with respect to other topics.

In one or more embodiments, the civic engagement system 106 generates the reputation scores based on a record of a user's contributions to the legal code repository. For example, a user's reputation score can be based on a number or percentage of proposals put forth by the user that are adopted, a number of likes of the user's comments or proposals, a number of comments on the user's proposals or comments, a number of shares of the user's proposals or comments, etc. Furthermore, the civic engagement system 106 can weight each of the foregoing or other factors when determining the reputation scores. For example, the number of proposals adopted can have a higher weight than the number of likes on comments. In any event, the civic engagement system 106 can generate reputation scores that reflect a user's contribution to legal code repository.

In one or more embodiments, the civic engagement system 106 grants reviewing and moderation authority to users in manner directly proportional to their associated reputations scores. For example, the civic engagement system 106 can allow users with a reputation score above a threshold to propose amendments to laws or code while preventing users with a reputation score below the threshold to propose amendments. In such embodiments, the civic engagement system 106 can allow users with reputation scores below the threshold to propose amendments in comments. Once such comments have a predetermined number of likes, the civic engagement system 106 can present the proposed amendments to the code as an official proposed amendment.

In one or more embodiments, the civic engagement system 106 prioritizes a display of the various comments within a new proposal interface. For example, in one or more embodiments, the civic engagement system 106 prioritizes display of the comments within a discussion interface based on a reputation score of the associated user. The civic engagement system 106 can prioritize comments based on general reputation scores, reputations scores for individual topics, or a combination of different reputations scores for a corresponding user. In one or more embodiments, the civic engagement system 106 further provides an indication (e.g., a display) of a relevant reputation score within the discussion interface. Further, in one or more embodiments, the civic engagement system 106 provides an indication of reputation score(s) within the original comment 404, thus indicating a high or low reputation for a user posting an original idea.

As further shown in FIG. 4A, the civic engagement system 106 provides one or more existing laws 410a-b similar to the proposed law within the digital forum. For example, upon determining that the posted comment 404 includes a proposal to change a required minimum of practice hours to qualify for a driver's license, the civic engagement system 106 identifies one or more existing laws that relate to a minimum number of hours required by various jurisdictions prior to qualifying for a driver's license. As shown in FIG. 4A, the civic engagement system 106 identifies example laws from Pittsburg and Boston that require 50 hours and 45 hours, respectively. Users providing comments within the new proposal interface 402 can view these laws for reference in discussing the proposed law.

In one or more embodiments, the civic engagement system 106 automatically, and without user input, identifies similar laws based on similar types of jurisdictions (e.g., cities/states having similar population demographics), proximity of jurisdictions, or similarity of existing laws between the different jurisdictions. In one or more embodiments, the civic engagement system 106 identifies similar laws based on received user input. For example, one or more members of the digital forum can identify a similar law and cause the civic engagement system 106 to provide the identified similar law within the graphical user interface 204, as shown in FIG. 4A.

In one or more embodiments, the civic engagement system 106 identifies similar laws 410a-b based on feedback 406 received within the discussion interface 402. For example, where a user is aware of a related law, the user can reference (e.g., @mention) or otherwise link a law from a different jurisdiction. In response, the civic engagement system 106 can query the legal repository 108 or third-party source and provide a copy of the similar law similar to the laws 410a-b listed within the graphical user interface 204 of FIG. 4A. In one or more embodiments, the civic engagement system 106 further enables those users having access to the discussion interface 402 to rate, comment on, or otherwise discuss the similar laws. Thus, the civic engagement system 106 facilitates the discovery of similar laws and allows jurisdictions to learn from each other.

In one or more embodiments, the civic engagement system 106 manages access to a discussion interface (e.g., the proposed law interface 402) based on a predicted interest by a given user in a topic of the discussion interface. For example, the civic engagement system 106 may determine that a user has an interest in all proposed laws for a particular jurisdiction and therefore provide access to all discussion interfaces within a digital forum for that jurisdiction. In addition, the civic engagement system 106 may determine that a user has an interest in a particular topic (e.g., based on profile information, a history of social networking posts, reputation score) and provide access to one or more discussion interfaces from various digital forums that enable the user to provide feedback in connection with proposed laws associated with a variety of jurisdictions.

The civic engagement system 106 can further provide one or more notifications associated with various proposals. For example, where profile information or a history of social networking posts indicates a high level of interest for a user in a particular topic, the civic engagement system 106 may provide a notification about any new law proposals related to the topic in a digital forum to which the user belongs. In one or more embodiments, the civic engagement system 106 additionally provides notifications for new law proposals from other jurisdictions (e.g., based on determining a predicted interest in the associated topic). Accordingly, in one or more embodiments, upon detecting that a user has posted a proposal predicted to be of interest to another user (e.g., based on factors indicating a high level of interest), the civic engagement system 106 provides a notification to users of the networking system 104 having a predicted interest in the proposed law. For example, the civic engagement system 106 can push notifications to devices associated with such users or to devices in which such users are logged into the networking system 104. In this manner, the civic engagement system 106 can automatically keep users abreast of potential laws and civic issues.

In one or more embodiments, the civic engagement system 106 monitors and aggregates the feedback 406 to proposals. For example, in one or more embodiments, the civic engagement system 106 monitors the ratings, comments, and/or comment ratings for the various responses to determine a consensus among users of the networking system 104 associated with the digital forum and/or those users having access to the new proposal interface 402.

Based on the aggregated feedback, the civic engagement system 106 can formalize the proposed law. For example, in one or more embodiments, the civic engagement system 106 monitors received ratings and/or additional feedback to determine that a threshold number or percentage of users associated with the digital forum approve the proposal. Accordingly, the civic engagement system 106 may provide a request or otherwise prompt one or more users of the networking system 104 (e.g., an identified legal expert associated with the digital forum) to draft a formalized proposal based on the text of the posted comment 404. Alternatively, in one or more embodiments, the civic engagement system 106 identifies a similar law from another jurisdiction that matches the proposed law and generates a formalized proposal based on the identified similar law.

As an alternative to approving the proposed law, in one or more embodiments, the civic engagement system 106 enables users having access to the proposed law interface 402 to edit or otherwise modify the proposal. For example, in one or more embodiments, the civic engagement system 106 provides an option to propose an amendment to the proposed law. Alternatively, in one or more embodiments, users can propose amendments in one or more comments within the proposed law interface 402. The civic engagement system 106 can further monitor ratings, reactions, or received comments in response to the proposed amendment to determine whether the community of users would prefer the amendment over the original proposed law.

In one or more embodiments, the civic engagement system 106 provides an interface that enables users to edit the proposal. For example, the civic engagement system 106 can provide an option to edit the proposal within the proposed law interface 402 (or via a separate interface within the graphical user interface 204). Upon detecting a selection of the option to edit the proposal, the civic engagement system 106 can provide an editing interface that enables users to submit differentials to the proposed law including, for example, amendments to text of a relevant legal code and/or the text of the posted comment 404 itself. In one or more embodiments, the civic engagement system 106 provides a display of the proposed amendments to the proposal and enables users to provide feedback for determining a version of the proposal to approve.

Similar to one or more embodiments described herein with regard to determining that users approve of a proposed law, the civic engagement system 106 can similarly determine whether users of the digital forum approve an amendment to a proposed law. For example, where a threshold number of users provide a positive rating or otherwise indicate approval of a proposed amendment, the civic engagement system 106 can indicate to users having access to the law proposal interface 402 that the amendment has been approved. In one or more embodiments, the civic engagement system 106 indicates approval of an amendment by replacing the proposed law with the amended proposal. For example, in one or more embodiments, the civic engagement system 106 replaces the entire proposed law interface 402 with a new interface including the amended proposal (and subsequently received feedback). Alternatively, in one or more embodiments, the civic engagement system 106 replaces the posted comment 404 with a new comment including the amended proposal.

The civic engagement system 106 can continue to monitor and aggregate feedback about the proposed amendment. Based on the feedback, the civic engagement system 106 can approve the amended proposal. In addition, the civic engagement system 106 can facilitate formalization of the amended proposal by copying a similar law and/or soliciting feedback from one or more users of the networking system 104 having expertise in preparing formalized proposals (e.g., a legal expert).

FIG. 4B illustrates an example formal proposal based on the proposal shown in FIG. 4A. For example, in one or more embodiments, upon detecting a threshold number of users that have approved the proposal, the civic engagement system 106 can generate a formalized proposal. In one or more embodiments, the civic engagement system 106 generates a formalized proposal interface 412 including the amended proposal 414 and a plain text description 416 of the formalized proposal. As further shown in FIG. 4B, the formalized proposal interface 412 includes feedback 418 including ratings and comments by various users of the networking system 104.

In one or more embodiments, the ratings and comments on proposals enable public agencies to make data-driven decisions. For example, the ratings and comments allow public agencies to make budgetary provisions based on direct feedback by constituents. Thus, the civic engagement system 106 facilitates the generation of user satisfaction data that can be utilized by the municipalities themselves to make data-driven budget decisions that more closely resemble citizen's priorities.

The civic engagement system 106 can also generate public agency scores. For example, based on the user reactions, the civic engagement system 106 can give specific municipalities an overall governance score. As an example, the civic engagement system 106 can score agencies based on how the reactions of users to laws implemented by the agency, the percentage of laws with high numbers of positive reactions that are implemented by the agency, or research establishing the effectiveness of laws enacted or enforced by the agency. In one or more embodiments, the civic engagement system 106 establishes a rank order of municipalities based on the governance scores. This can foster a healthy competition between agencies to improve their rankings.

In one or more embodiments, the civic engagement system 106 further provides an edit history for a formalized proposal. For example, as shown in FIG. 4B, the amended proposal 414 includes iterations 420 of the proposed law including one or more previous version of the law. In particular, the iterations 420 include a 2015 version of the law at issue in which a requirement was added to require that a supervising licensed driver be 25 years of age. In addition, the iterations 420 include a most recent 2017 version of the law (e.g., based on the formalized proposal and/or amendments) including the proposed change to the existing law from requiring a minimum of 20 hours driving to a minimum of 50 hours driving to qualify for the driver's license exam.

In addition to the foregoing, the civic engagement system 106 can supplement the amended proposal 414 with links to research papers and scholarly articles supporting the argument for the proposed amendment. In one or more embodiments, the amended proposal 414 automatically, and without user input, provides such links by searching the legal repository. For example, in one or more embodiments the civic engagement system 106 can find laws similar to the proposal from other jurisdictions and identify papers or research that support such implemented laws. Alternatively, the civic engagement system 106 can use natural language processing to identify a theme of the proposal and then search for articles or research supporting the theme.

In one or more embodiments, the civic engagement system 106 weights proposals based on the supporting research. For example, the civic engagement system 106 can identify that Pittsburgh has an in-force law on its books. The civic engagement system 106 can determine, or find an article that determines, any changes in accidents, tickets, insurance claims, etc. by new drivers in Pittsburgh both before and after the enactment of the similar law 410a. If the research indicates a reduction in accidents, tickets, insurance claims, etc. by new drivers, the civic engagement system 106 can heavily weight the proposal 414. If there is no supporting research or negative research, the civic engagement system 106 can provide no weight or a negative weight to the proposal 414.

In one or more embodiments, the civic engagement system 106 provides amendment proposals to a plurality of reviewers. The reviewers can comprise elected officials, users with high reputation scores, members of the jurisdiction, etc. In one or more embodiments, the civic engagement system 106 can require approval from a predetermined number of reviewers whose aggregate reputation score passes a predetermined threshold. Alternatively, the civic engagement system 106 can require a predetermined percentage of the reviewers to approve a proposal.

As shown by FIGS. 4A and 4B, the civic engagement system 106 allows for differential submission, review, acceptance, rejection, and commenting on proposals to code, laws, regulations, and other civic matters. Thus, the civic engagement system 106 facilitates multiple users in different locations and at different times to collaborate to improve, revise, and implement laws, code, regulations, etc.

While FIGS. 3A-4B illustrate examples in which users of a digital forum and/or users having access to an individual discussion interface collaborate to generate new laws and/or amendments to existing laws, the civic engagement system 106 can utilize similar features and functionality to enable users of the networking system 104 to modify other content on a legal repository 108. For example, while FIGS. 3A-4B describe instances of users discussing and amending local laws and ordinances, the civic engagement system 106 further enables users of the networking system 104 to engage in civic issues on a state, national, or international scale. Further, in addition to discussing new proposals and amendments to laws, communities of users can further collaborate on contemporary solutions to larger problems including, for example, global warming, national elections, and other initiatives. Accordingly, while one or more embodiments described herein relate primarily to local issues and laws, features and functionality described in connection with local jurisdictions can similarly be applied to larger jurisdictions for which a much larger portion of the user base of the networking system 104 may participate.

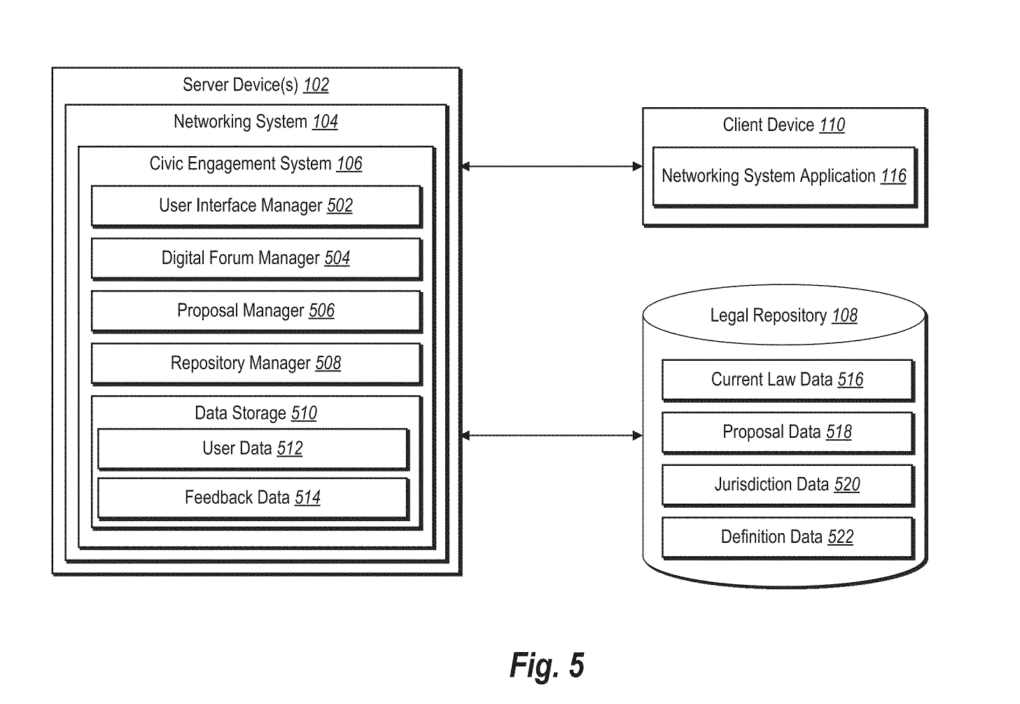

Turning now to FIG. 5, additional detail will be provided regarding components and capabilities of example architecture for the civic engagement system 106 that may be implemented within a communication environment 100 including a server device(s) 102, client device 110, and legal repository 108. In particular, FIG. 5 illustrates one implementation of the server device(s) 102, client device 110, and legal repository 108 having similar features and functionality associated with one or more embodiments described above. For example, the civic engagement system 106 and networking system 104 cooperate to provide features and functionality of civic engagement forums (e.g., digital forums) for facilitating engagement in civic discussion between users of the networking system 104.

In particular, as shown in FIG. 5, the server device(s) 102 includes a networking system 104, which includes the civic engagement system 106. As further shown, the civic engagement system 106 includes a user interface manager 502, digital forum manager 504, proposal manager 506, repository manager 508, and a data storage 510 including user data 512 and feedback data 514. As further shown, FIG. 5 illustrates an example client device 110 including a networking system application 112 thereon. Moreover, FIG. 5 illustrates a legal repository 108 including current law data 516, proposal data 518, jurisdiction data 520, and definition data 522.

While FIG. 5 shows one example embodiment in which the components 502-514 are implemented on the server device(s) 102 and components 516-522 are implemented on the legal repository 108, it will be understood that one or more of the components 502-522 may be implemented wholly or partially on the server device(s) 102, client device 110, legal repository 108, or a combination of the illustrated devices. As an example, the user data 512, feedback data 514, current law data 516, proposal data 518, jurisdiction data 520, and definition data 522 can be located within corresponding storage spaces on the server device(s) 102, client device 110, and/or legal repository 108 and/or collectively between storage spaces accessible to the server device(s) 102 and/or client device 110.

As discussed in one or more embodiments, the civic engagement system 106 can provide a graphical user interface via a display of the client device 110. For example, as shown in FIG. 5, the civic engagement system 106 includes the user interface manager 502 that provides a graphical user interface via the client device 110. In one or more embodiments, the user interface manager 502 generates, creates, and/or provides any graphical user interface associated with the networking system 104. Examples of the civic engagement system 106 causing the client device 110 to provide a graphical user interface are described above in connection with FIGS. 2-4B. Accordingly, the user interface manager 502 provides a graphical user interface that enables a user of the client device 110 to interact and engage with other users of the networking system 104 about various topics.

In particular, as discussed above, the civic engagement system 106 configures and provides access to digital forums associated with various jurisdictions. For example, as shown in FIG. 5, the civic engagement system 106 includes a digital forum manager 504 that facilitates configuration of digital forums and management of access to various digital forums. For instance, the digital forum manager 504 configures a digital forum by creating a page or series of connected pages for a jurisdiction and causes the user interface manager 502 to provide the digital forum, including any number of discussion interfaces having content associated with the jurisdiction. For example, the digital forum manager 504 can provide discussion interfaces for existing laws of the jurisdiction. In one or more embodiments, the digital forum manager 504 provides a digital forum including a discussion interface for each respective law of the jurisdiction.

In addition to configuring the digital forums, the digital forum manager 504 further manages access to respective digital forums. For example, where the digital forum manager 504 configures a digital forum associated with a jurisdiction, the digital forum manager 504 provides access to those users of the networking system 104 associated with the jurisdiction. For example, based on profile information, user preferences, and/or one or more received user inputs, the digital forum manager 504 can limit access to a digital forum for a jurisdiction to those users having a connection to or unique interest in the jurisdiction.

As further discussed above, the civic engagement system 106 facilitates various proposals for new laws and/or changes to existing laws. For example, as shown in FIG. 5, the civic engagement system 106 includes a proposal manager 506 that enables a user of the client device 110 to compose a new proposal including a proposed law or change to an existing law. In particular, in one or more embodiments, the user interface manager 502 provides one or more selectable options via a graphical user interface that enables the user to compose a comment including a written proposal. Using natural language processing or other analysis techniques, the proposal manager 506 can identify a proposal within the comment and configure a new discussion interface within the digital forum including the written proposal.

Upon presenting the proposal within the digital forum, the proposal manager 506 can collect and aggregate feedback from a group of users of the networking system 104 having access to the proposal and determine whether a consensus of the group of users agrees with or disagrees with the proposal. For example, where a threshold of users provides a positive rating (e.g., thumbs up or positive comment) within a discussion interface of the proposal, the proposal manager 506 can identify the proposal as approved and proceed onto generating a formalized proposal. Alternatively, where less than a threshold of users provides a positive rating, or a threshold number of users provide a negative rating within the discussion interface, the proposal manager 506 can identify the proposal as not approved and delete or otherwise remove the discussion interface from the digital forum.

In one or more embodiments, the proposal manager 506 enables users of the networking system 104 to amend or otherwise modify a proposal. For example, where a user proposes an amendment to a proposal that receives a more positive response from users of the digital forum, the proposal manager 506 can determine that the amendment to the proposal better represents the consensus of users of the digital forum. Accordingly, in one or more embodiments, the proposal manager 506 replaces the discussion interface including the original proposal with a discussion interface including the amended proposal. For example, the proposal manager 506 can delete the original proposal and provide a new discussion interface including the amended proposal.

In addition to facilitating discussion and approval of various proposals, the proposal manager 506 can further formalize a proposal. For example, in response to determining that the users of a digital forum approve a given proposal, the proposal manager 506 can facilitate creation of a formalized proposal including text of a proposed law and a plain language description of the text. In one or more embodiments, the proposal manager 506 identifies the text and plain language from a similar law of another jurisdiction. Alternatively, in one or more embodiments, the proposal manager 506 provides a notification including a request to one or more users of the networking system 104 having a unique qualification to compose the text and/or plain language of the formalized proposal.

In one or more embodiments, the proposal manager 506 further provides the text and plain language of the formalized proposal for further discussion among users of the digital forum. For example, the proposal manager 506 enables users having access to the proposal (and formalized proposal) to fine-tune the text and plain language to ultimately arrive at an approved version of the proposal. In one or more embodiments, the proposal manager 506 replaces an existing law with the final approved version of the proposal. Alternatively, in one or more embodiments, the proposal manager 506 identifies the final approved version and provides the final approved version to a representative or other government entity having a position or authority to propose the law on an official level.

In configuring the digital forum and managing approval of various proposals, the civic engagement system 106 can utilize resources of a legal repository 108. For example, as shown in FIG. 5, the civic engagement system 106 includes a repository manager 508 that manages data on the legal repository 108. For example, in one or more embodiments, the repository manager 508 manages access to various third-party sources including information used to generate digital forums and/or discussion interfaces. In addition, the repository manager 508 can construct portions of the legal repository 108 including proposals, amendments, and various feedback received via the digital forums.

As shown in FIG. 5, the civic engagement system 106 includes a data storage 510 including user data 512. The user data 512 can include any information associated with a user of the networking system 104. For example, the user data 512 can include profile information including location(s), demographics, relationships, and other information associated with a given user account. In one or more embodiments, the user data 512 includes a history of social networking interactions including, for example, ratings and comments from the user in addition to ratings and comments in response to the user.

As further shown, the data storage 510 includes feedback data 514 including ratings, comments, and other feedback received in response to various proposals. For example, where a user proposes a new law, the feedback data 514 can include any comments, ratings, or associated feedback provided by users of the networking system. As will be described in further detail below, the civic engagement system 106, including the repository manager 508, can utilize the user data 512, feedback data 514, and any additional information stored by the civic engagement system 106 within the data storage 510 to manage the legal repository 108.

As mentioned above, the legal repository 108 includes information useful for enhancing civic discussion between users associated with a digital forum. For example, as shown in FIG. 5, the legal repository 108 includes current law data 516 including any information about existing laws from respective jurisdictions. In one or more embodiments, the repository manager 508 collects current law data 516 from various third-party sources. For example, the repository manager 508 can retrieve original text from titles and codes from respective city or county websites and/or government databases including text of existing laws and associated legislative histories.

In addition, in one or more embodiments, the repository manager 508 collects current law data 516 from users of the networking system 104. In particular, in one or more embodiments, the repository manager 508 utilizes resources of the networking system 104 to supplement the current law data 516 obtained from government and other third-party sources. For example, in one or more embodiments, users of the networking system 104 provide plain language descriptions of existing laws, which the repository manager 508 stores in the legal repository 108 with other current law data 516.

As further shown, the legal repository includes proposal data 518 including proposals by users and associated feedback to proposals. For example, in one or more embodiments, the proposal data 518 includes original text of a proposal and associated feedback. In addition, the proposal data 518 can include proposed amendments, associated feedback, and a history of edits or modifications leading up to a formalized proposal and final version of the proposal.

The legal repository includes jurisdiction data 520 including information about jurisdictions as well as relationships of users with respective jurisdictions. For example, the jurisdiction data 520 can include geographic constraints of a jurisdiction as well as an identification of addresses that fall within a jurisdiction. In one or more embodiments, the jurisdiction information 520 includes membership information including an identification of users associated with respective jurisdictions. For example, in one or more embodiments, the repository manager 508 identifies correlations between user data 512 of the data storage 510 and identifies those users of the networking system 104 that live within a jurisdiction or otherwise have a distinct relationship with the jurisdiction.

The legal repository further includes definition data 522 including definitions of various terms and phrases used in connection with various topics. For example, the definition data 522 can include definitions of unique terms often used in connection with various civic topics. In one or more embodiments, the repository manager 508 manages the definition data 522 by updating definitions as they evolve among users of the networking system 104. As an example, where definitions and metrics associated with “global warming” or “climate change” may change over time as additional information becomes known or available, the repository manager 508 can update corresponding definition data 522 accordingly. In one or more embodiments, the repository manager 508 updated definition data 522 similar to one or more embodiments described above in connection with approving and/or modifying language of proposals.

In one or more embodiments, the civic engagement system 106 stores data in the legal repository 108 in a variety of formats. For example, in one or more embodiments, the data stored in the legal repository 108 conforms to Semantic Web standards as described by the World Wide Web Consortium (W3C). In one or more embodiments, the civic engagement system 106 formats the legal code in the repository using a resource description framework (RDF) format. By storing data within the legal repository 108 using an RDF format, the civic engagement system 106 utilizes a format that enables data to be shared and reused across applications and community boundaries.

In one or more embodiments, the civic engagement system 106 stores legal code and other data within the legal repository using Web Ontology Language (OWL). For example, in one or more embodiments, the civic engagement system 106 utilizes OWL to construct the definition data 522 including vocabulary used in connection with different laws and proposals. In this way, the civic engagement system 106 can ensure that various terms and vocabulary has a similar meaning across jurisdictions and in connection with different laws.

As mentioned above, the civic engagement system 106 enables users of the networking system 104 to cooperatively create proposals, amendments to proposals, modifications of definitions, etc. In one or more embodiments, these various proposals enact changes to data contained within the legal repository 108. In monitoring and aggregating the feedback including various changes, the civic engagement system 106 maintains block chains for respective laws, proposals, and other topics. Accordingly, the civic engagement system 106 maintains a record including a block chain for respective laws, including any changes to the laws as well as proposals, amendments to proposals, etc. The civic engagement system 106 similarly can maintain records including block chains for definitions, new proposals, changes in jurisdictions, and other types of data stored or referenced by the legal repository 108. In one or more embodiments, the civic engagement system 106 stores the block chains within the legal repository 108.

As an illustrative example, the civic engagement system 106 maintains a block chain having a main chain that includes an original block that refers to an original law (e.g., a non-modified law). The block chain can further include a main chain including proposals (e.g., plain language proposals, formalized proposals) that result in approval by users of the networking system 104. The block chain can further include one or more secondary blocks (e.g., orphan blocks) or breakoff chains including proposals and/or any associated amendments that fail to receive approval from users of the networking system 104. The civic engagement system 106 can maintain block chains for laws, definitions, or any type of data maintained on the legal repository 108 and store the block chains within the legal repository 108.

In one or more embodiments, the civic engagement system 106 stores data within the legal repository using a query language that enables the civic engagement system 106 to query global databases. For example, in one or more embodiments, the civic engagement system 106 utilizes a SPARQL Protocol and RDF query language including a semantic query language for searching databases (e.g., remote databases). By using a uniform query language, the civic engagement system 106 facilitates querying various remote databases and constructing the legal repository 108 to include data from various sources and/or links to various sources using a uniform format.

Moreover, in one or more embodiments, the legal repository 108 provides application programming interfaces (APIs) to users of the networking system. In particular, the civic engagement system 106 provides APIs to developers to facilitate building utility application that include translation and research tools. In one or more embodiments, utilizing APIs enables the civic engagement system 106 to provide research information and information from different languages or having different formats that enable users to more effectively engage in various issues.

Each of the components 502-522 can comprise software, hardware, or both. For example, the components 502-522 can comprise one or more instructions stored on a computer-readable storage medium and executable by processors of one or more computing devices. When executed by the one or more processors, the computer-executable instructions of the civic engagement system 106 can cause a client device and/or a server device to perform the methods described herein. Alternatively, the components 502-522 and their corresponding elements can comprise hardware, such as a special purpose processing device to perform a certain function or group of functions. Additionally, the components 502-522 can comprise a combination of computer-executable instructions and hardware.

Furthermore, the components 502-522 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 502-522 may be implemented as a stand-alone application, such as a desktop or mobile application. Furthermore, the components 502-522 may be implemented as one or more web-based applications hosted on a remote server. The components 502-522 may also be implemented in a suit of mobile device applications or “apps.”

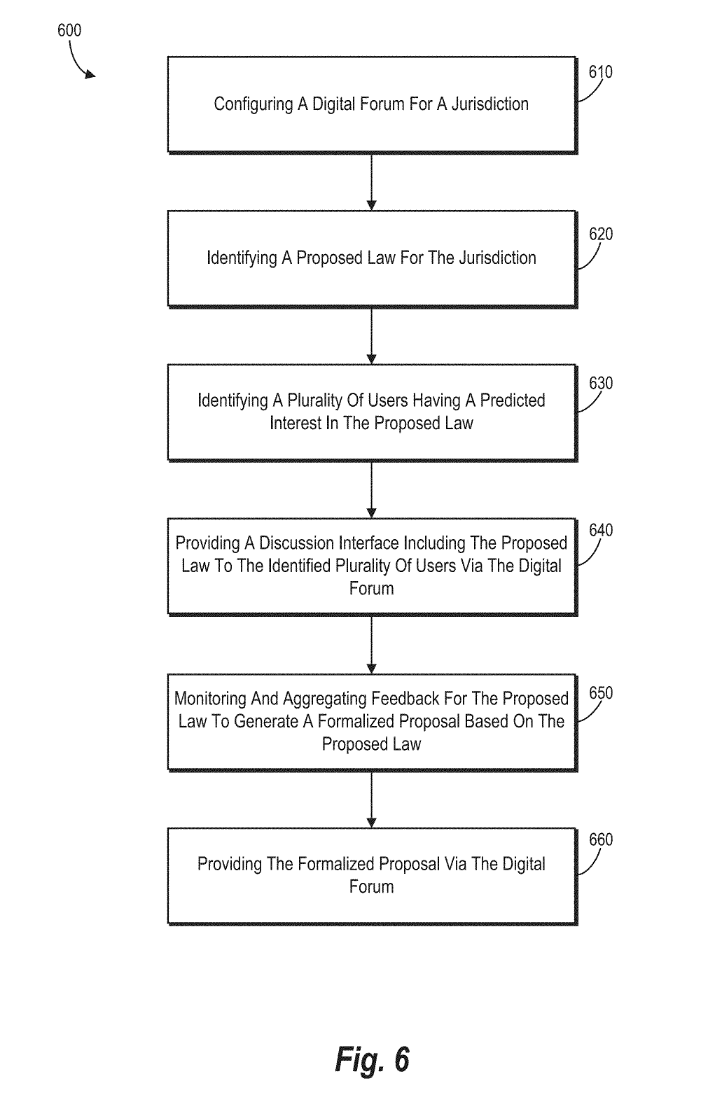

FIGS. 1-5, the corresponding text, and the examples, provide a number of different systems and devices that facilitate enhancement of civic dialog between users of the networking system 104. Turning now to FIG. 6, this figure illustrates a flowchart of a series of acts 600 for proposing a law and generating a formalized proposal in accordance with one or more embodiments. While FIG. 6 illustrates acts according to one embodiment, alternative embodiments may omit, add to, reorder, and/or modify any of the acts shown in FIG. 6. The acts of FIG. 6 can be performed as part of a method. Alternatively, a non-transitory computer readable medium can comprise instructions, that when executed by one or more processors, cause a computing device to perform the acts of FIG. 6. In still further embodiments, a system can perform the acts of FIG. 6.

FIG. 6 illustrates a flowchart of acts 600 for facilitating engagement in civic issues between users of a networking system 104. As shown in FIG. 6, the acts 600 include an act 610 of configuring a digital forum for a jurisdiction. For example, in one or more embodiments, the act 610 includes configuring, by a networking system 104, a digital forum for a jurisdiction that allows users of the networking system 104 to provide feedback for civic issues associated with the jurisdiction. In one or more embodiments, the acts 600 include providing a plurality of discussion interfaces for a plurality of existing laws of the jurisdiction where the plurality of discussion interfaces includes at least one discussion interface for each of the plurality of existing laws.

As further shown in FIG. 6, the acts 600 include an act 620 of identifying a proposed law for the jurisdiction. In one or more embodiments, identifying the proposed law includes receiving, from a user associated with the jurisdiction, a proposed change to an existing law for the jurisdiction. In one or more embodiments, the proposed law includes a plain language description of a proposed law. For example, the proposed law may include a posted comment within an interface of the digital forum including a plain language description of a proposal for a change to an existing law.

As further shown in FIG. 6, the acts 600 include an act 630 of identifying a plurality of users having a predicted interest in the proposal. For example, in one or more embodiments, the act 630 includes identifying, based on social networking data, a plurality of users of the networking system having a predicted interest in the proposed law. In one or more embodiments, identifying the plurality of users includes identifying, based on the social networking data, users of the networking system 104 that live within a geographic boundary associated with the jurisdiction. In one or more embodiments, identifying the plurality of users further includes identifying, based on the social networking data, one or more users of the networking system 104 having reputation scores that exceed a threshold reputation score for a topic of the proposed law.

As further shown in FIG. 6, the acts 600 include an act 640 of providing a discussion interface including the proposed law to the identified plurality of users via the digital forum. For example, in one or more embodiments, the act 640 includes providing, to the identified plurality of users via the digital forum for the jurisdiction, a discussion interface including the proposed law. In one or more embodiments, the acts 600 include identifying one or more similar laws to the proposed law from other jurisdictions. In one or more embodiments, the acts 600 include providing, via the digital forum, the one or more similar laws and associated feedback from users of the networking system 104 with regard to the one or more similar laws.

As further shown in FIG. 6, the acts 600 include an act 650 of monitoring and aggregating feedback for the proposed law to generate a formalized proposal based on the proposed law. For example, in one or more embodiments, the act 650 includes monitoring and aggregating feedback for the proposed law from the plurality of users within the discussion interface to generate a formalized proposal based on the proposed law. In one or more embodiments, monitoring and aggregating feedback for the proposed law includes aggregating user ratings, comments, and one or more proposed edits to the proposed law from the plurality of users within the discussion interface.

In one or more embodiments, the monitoring and aggregating feedback to the proposed law includes prioritizing feedback from the plurality of users based on reputation scores associated with the plurality of users. In one or more embodiments, the reputation scores include topic-specific reputation scores based on determined reputations for the plurality of users corresponding to a topic of the proposed law. In addition, in one or more embodiments, monitoring and aggregating feedback to the proposed law includes prioritizing feedback from users of the plurality of users that live within the geographic boundary of the jurisdiction.

As further shown in FIG. 6, the acts 600 include an act 660 of providing the formalized proposal via the digital forum. For example, in one or more embodiments, the act 660 includes providing, to the plurality of users via the digital forum, the formalized proposal. In one or more embodiments, the acts 600 further include adding the proposed law and the formalized proposal to a block chain associated with an existing law of the jurisdiction stored within a legal repository accessible to the networking system 104. In one or more embodiments, adding the proposed law and the formalized proposal to the block chain includes adding the proposed law and the formalized proposal to the block chain in response to detecting that a threshold number of the plurality of users has approved the formalized proposal.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred, or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates, in block diagram form, an exemplary computing device 700 that may be configured to perform one or more of the processes described above. In one or more embodiments, the server device(s) 102, client devices 110a-n, 202 each comprise one or more computing devices in accordance with implementations of computing device 700. As shown by FIG. 7, the computing device can comprise a processor 702, a memory 704, a storage device 706, an I/O interface 708, and a communication interface 710, which may be communicatively coupled by way of communication infrastructure 712. While an exemplary computing device 700 is shown in FIG. 7, the components illustrated in FIG. 7 are not intended to be limiting. Additional or alternative components may be used in other embodiments. Furthermore, in certain embodiments, a computing device 700 can include fewer components than those shown in FIG. 7. Components of computing device 700 shown in FIG. 7 will now be described in additional detail.

In particular embodiments, processor 702 includes hardware for executing instructions, such as those making up a computer program. As an example, and not by way of limitation, to execute instructions, processor 702 may retrieve (or fetch) the instructions from an internal register, an internal cache, memory 704, or storage device 706 and decode and execute them. In particular embodiments, processor 702 may include one or more internal caches for data, instructions, or addresses. As an example, and not by way of limitation, processor 702 may include one or more instruction caches, one or more data caches, and one or more translation lookaside buffers (TLBs). Instructions in the instruction caches may be copies of instructions in memory 704 or storage 706.

Memory 704 may be used for storing data, metadata, and programs for execution by the processor(s). Memory 704 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. Memory 704 may be internal or distributed memory.

Storage device 706 includes storage for storing data or instructions. As an example, and not by way of limitation, storage device 706 can comprise a non-transitory storage medium described above. Storage device 706 may include a hard disk drive (HDD), a floppy disk drive, flash memory, an optical disc, a magneto-optical disc, magnetic tape, or a Universal Serial Bus (USB) drive or a combination of two or more of these. Storage device 706 may include removable or non-removable (or fixed) media, where appropriate. Storage device 706 may be internal or external to the computing device 700. In particular embodiments, storage device 706 is non-volatile, solid-state memory. In other embodiments, Storage device 706 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 708 allows a user to provide input to, receive output from, and otherwise transfer data to and receive data from computing device 700. I/O interface 708 may include a mouse, a keypad or a keyboard, a touch screen, a camera, an optical scanner, network interface, modem, other known I/O devices or a combination of such I/O interfaces. I/O interface 708 may include one or more devices for presenting output to a user, including, but not limited to, a graphics engine, a display (e.g., a display screen), one or more output driver's (e.g., display driver's), one or more audio speakers, and one or more audio driver's. In certain embodiments, I/O interface 708 is configured to provide graphical data to a display for presentation to a user. The graphical data may be representative of one or more graphical user interfaces and/or any other graphical content as may serve a particular implementation.

Communication interface 710 can include hardware, software, or both. In any event, communication interface 710 can provide one or more interfaces for communication (such as, for example, packet-based communication) between computing device 700 and one or more other computing devices or networks. As an example, and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI.

Additionally, or alternatively, communication interface 710 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 710 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof

Communication infrastructure 712 may include hardware, software, or both that couples components of computing device 700 to each other. As an example and not by way of limitation, communication infrastructure 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, in one or more embodiments, the networking system 104 is linked to and/or is implemented as a social networking system. A social-networking system may enable its users (such as persons or organizations) to interact with the system and with each other. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may store records of users and relationships between users in a social graph comprising a plurality of nodes and a plurality of edges connecting the nodes. The nodes may comprise a plurality of user nodes and a plurality of concept nodes. A user node of the social graph may correspond to a user of the social-networking system. A user may be an individual (human user), an entity (e.g., an enterprise, business, or third party application), or a group (e.g., of individuals or entities). A user node corresponding to a user may comprise information provided by the user and information gathered by various systems, including the social-networking system.

For example, the user may provide his or her name, profile picture, city of residence, contact information, birth date, gender, marital status, family status, employment, educational background, preferences, interests, and other demographic information to be included in the user node. Each user node of the social graph may have a corresponding web page (typically known as a profile page). In response to a request including a user name, the social-networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

A concept node may correspond to a concept of the social-networking system. For example, a concept can represent a real-world entity, such as a movie, a song, a sports team, a celebrity, a group, a restaurant, or a place or a location. An administrative user of a concept node corresponding to a concept may create or update the concept node by providing information of the concept (e.g., by filling out an online form), causing the social-networking system to associate the information with the concept node. For example, and without limitation, information associated with a concept can include a name or a title, one or more images (e.g., an image of cover page of a book), a web site (e.g., an URL address) or contact information (e.g., a phone number, an email address). Each concept node of the social graph may correspond to a web page. For example, in response to a request including a name, the social-networking system can access a concept node corresponding to the name, and construct a web page including the name and other information associated with the concept.

An edge between a pair of nodes may represent a relationship between the pair of nodes. For example, an edge between two user nodes can represent a friendship between two users. For another example, the social-networking system may construct a web page (or a structured document) of a concept node (e.g., a restaurant, a celebrity), incorporating one or more selectable buttons (e.g., “like”, “check in”) in the web page. A user can access the page using a web browser hosted by the user's client device and select a selectable button, causing the client device to transmit to the social-networking system a request to create an edge between a user node of the user and a concept node of the concept, indicating a relationship between the user and the concept (e.g., the user checks in to a restaurant, or the user “likes” a celebrity).

As an example, a user may provide (or change) his or her city of residence, causing the social-networking system to create an edge between a user node corresponding to the user and a concept node corresponding to the city declared by the user as his or her city of residence. In addition, the degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.”

A social-networking system may support a variety of applications, such as photo sharing, on-line calendars and events, gaming, instant messaging, and advertising. For example, the social-networking system may also include media sharing capabilities. Also, the social-networking system may allow users to post photographs and other multimedia files to a user's profile page (e.g., timeline)” or in a photo album, both of which may be accessible to other users of the social-networking system depending upon the user's configured privacy settings. The social-networking system may also allow users to configure events. For example, a first user may configure an event with attributes including time and date of the event, location of the event and other users invited to the event. The invited users may receive invitations to the event and respond (such as by accepting the invitation or declining it). Furthermore, the social-networking system may allow users to maintain a personal calendar. Similar to events, the calendar entries may include times, dates, locations and identities of other users.

FIG. 8 illustrates an example network environment 800 of a social-networking system. In particular embodiments, a social-networking system 802 may comprise one or more data stores. In particular embodiments, the social-networking system 802 may store a social graph comprising user nodes, concept nodes, and edges between nodes as described earlier. Each user node may comprise one or more data objects corresponding to information associated with or describing a user. Each concept node may comprise one or more data objects corresponding to information associated with a concept. Each edge between a pair of nodes may comprise one or more data objects corresponding to information associated with a relationship between users (or between a user and a concept, or between concepts) corresponding to the pair of nodes.

In particular embodiments, the social-networking system 802 may comprise one or more computing devices (e.g., servers) hosting functionality directed to operation of the social-networking system 802. A user of the social-networking system 802 may access the social-networking system 802 using a client device such as client device 806. In particular embodiments, the client device 806 can interact with the social-networking system 802 through a network 804.

The client device 806 may be a desktop computer, a laptop computer, a tablet computer, a personal digital assistant (PDA), an in- or out-of-car navigation system, a smart phone or other cellular or mobile phone, or a mobile gaming device, other mobile device, or other suitable computing devices. Client device 806 may execute one or more client applications, such as a web browser (e.g., Microsoft Windows Internet Explorer, Mozilla Firefox, Apple Safari, Google Chrome, Opera, etc.) or a native or special-purpose client application (e.g., Facebook for iPhone or iPad, Facebook for Android, etc.), to access and view content over network 804.

Network 804 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 806 may access the social-networking system 802.

While these methods, systems, and user interfaces utilize both publicly available information as well as information provided by users of the social-networking system, all use of such information is to be explicitly subject to all privacy settings of the involved users and the privacy policy of the social-networking system as a whole.

FIG. 9 illustrates example social graph 900. In particular embodiments, social networking system 802 may store one or more social graphs 900 in one or more data stores. In particular embodiments, social graph 900 may include multiple nodes—which may include multiple user nodes 902 or multiple concept nodes 904—and multiple edges 906 connecting the nodes. Example social graph 900 illustrated in FIG. 9 is shown, for didactic purposes, in a two-dimensional visual map representation. In particular embodiments, a social networking system 802, client device 806, or third-party system 808 may access social graph 900 and related social-graph information for suitable applications. The nodes and edges of social graph 900 may be stored as data objects, for example, in a data store (such as a social-graph database). Such a data store may include one or more searchable or query able indexes of nodes or edges of social graph 900.

In particular embodiments, a user node 902 may correspond to a user of social networking system 802. As an example, and not by way of limitation, a user may be an individual (human user), an entity (e.g., an enterprise, business, or third-party application), or a group (e.g., of individuals or entities) that interacts or communicates with or over social networking system 802. In particular embodiments, when a user registers for an account with social networking system 802, social networking system 802 may create a user node 902 corresponding to the user, and store the user node 902 in one or more data stores. Users and user nodes 902 described herein may, where appropriate, refer to registered users and user nodes 902 associated with registered users. In addition, or as an alternative, users and user nodes 902 described herein may, where appropriate, refer to users that have not registered with social networking system 802. In particular embodiments, a user node 902 may be associated with information provided by a user or information gathered by various systems, including social networking system 802. As an example, and not by way of limitation, a user may provide his or her name, profile picture, contact information, birth date, sex, marital status, family status, employment, education background, preferences, interests, or other demographic information. Each user node of the social graph may have a corresponding web page (typically known as a profile page). In response to a request including a user name, the social networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

In particular embodiments, a concept node 904 may correspond to a concept. As an example and not by way of limitation, a concept may correspond to a place (such as, for example, a movie theater, restaurant, landmark, or city); a website (such as, for example, a website associated with social-network system 802 or a third-party website associated with a web-application server); an entity (such as, for example, a person, business, group, sports team, or celebrity); a resource (such as, for example, an audio file, video file, digital photo, text file, structured document, or application) which may be located within social networking system 802 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 904 may be associated with information of a concept provided by a user or information gathered by various systems, including social networking system 802. As an example, and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 904 may be associated with one or more data objects corresponding to information associated with concept node 904. In particular embodiments, a concept node 904 may correspond to one or more webpages.

In particular embodiments, a node in social graph 900 may represent or be represented by a webpage (which may be referred to as a “profile page”). Profile pages may be hosted by or accessible to social networking system 802. Profile pages may also be hosted on third-party websites associated with a third-party system 808. As an example, and not by way of limitation, a profile page corresponding to a particular external webpage may be the particular external webpage and the profile page may correspond to a particular concept node 904. Profile pages may be viewable by all or a selected subset of other users. As an example, and not by way of limitation, a user node 902 may have a corresponding user-Attorney profile page in which the corresponding user may add content, make declarations, or otherwise express himself or herself. As another example and not by way of limitation, a concept node 904 may have a corresponding concept-profile page in which one or more users may add content, make declarations, or express themselves, particularly in relation to the concept corresponding to concept node 904.

In particular embodiments, a concept node 904 may represent a third-party webpage or resource hosted by a third-party system 808. The third-party webpage or resource may include, among other elements, content, a selectable or other icon, or other inter-actable object (which may be implemented, for example, in JavaScript, AJAX, or PHP codes) representing an action or activity. As an example, and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client device 806 to send to social networking system 802 a message indicating the user's action. In response to the message, social networking system 802 may create an edge (e.g., an “eat” edge) between a user node 902 corresponding to the user and a concept node 904 corresponding to the third-party webpage or resource and store edge 906 in one or more data stores.

In particular embodiments, a pair of nodes in social graph 900 may be connected to each other by one or more edges 906. An edge 906 connecting a pair of nodes may represent a relationship between the pair of nodes. In particular embodiments, an edge 906 may include or represent one or more data objects or attributes corresponding to the relationship between a pair of nodes. As an example, and not by way of limitation, a first user may indicate that a second user is a “friend” of the first user. In response to this indication, social networking system 802 may send a “friend request” to the second user. If the second user confirms the “friend request,” social networking system 802 may create an edge 906 connecting the first user's user node 902 to the second user's user node 902 in social graph 900 and store edge 906 as social-graph information in one or more of data stores. In the example of FIG. 9, social graph 900 includes an edge 906 indicating a friend relation between user nodes 902 of user “A” and user “B” and an edge indicating a friend relation between user nodes 902 of user “C” and user “B.” Although this disclosure describes or illustrates particular edges 906 with particular attributes connecting particular user nodes 902, this disclosure contemplates any suitable edges 906 with any suitable attributes connecting user nodes 902. As an example, and not by way of limitation, an edge 906 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 900 by one or more edges 906.

In particular embodiments, an edge 906 between a user node 902 and a concept node 904 may represent a particular action or activity performed by a user associated with user node 902 toward a concept associated with a concept node 904. As an example, and not by way of limitation, as illustrated in FIG. 9, a user may “like,” “attended,” “played,” “listened,” “cooked,” “worked at,” or “watched” a concept, each of which may correspond to an edge type or subtype. A concept-profile page corresponding to a concept node 904 may include, for example, a selectable “check in” icon (such as, for example, a clickable “check in” icon) or a selectable “add to favorites” icon. Similarly, after a user clicks these icons, social networking system 802 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social networking system 802 may create a “listened” edge 906 and a “used” edge (as illustrated in FIG. 9) between user nodes 902 corresponding to the user and concept nodes 904 corresponding to the song and application to indicate that the user listened to the song and used the application. Moreover, social networking system 802 may create a “played” edge 906 (as illustrated in FIG. 9) between concept nodes 904 corresponding to the song and the application to indicate that the particular song was played by the particular application. In this case, “played” edge 906 corresponds to an action performed by an external application (SPOTIFY) on an external audio file (the song “Imagine”). Although this disclosure describes particular edges 906 with particular attributes connecting user nodes 902 and concept nodes 904, this disclosure contemplates any suitable edges 906 with any suitable attributes connecting user nodes 902 and concept nodes 904. Moreover, although this disclosure describes edges between a user node 902 and a concept node 904 representing a single relationship, this disclosure contemplates edges between a user node 902 and a concept node 904 representing one or more relationships. As an example, and not by way of limitation, an edge 906 may represent both that a user likes and has used at a particular concept. Alternatively, another edge 906 may represent each type of relationship (or multiples of a single relationship) between a user node 902 and a concept node 904 (as illustrated in FIG. 9 between user node 902 for user “E” and concept node 904 for “SPOTIFY”).

In particular embodiments, social networking system 802 may create an edge 906 between a user node 902 and a concept node 904 in social graph 900. As an example and not by way of limitation, a user viewing a concept-profile page (such as, for example, by using a web browser or a special-purpose application hosted by the user's client device 806) may indicate that he or she likes the concept represented by the concept node 904 by clicking or selecting a “Like” icon, which may cause the user's client device 806 to send to social networking system 802 a message indicating the user's liking of the concept associated with the concept-profile page. In response to the message, social networking system 802 may create an edge 906 between user node 902 associated with the user and concept node 904, as illustrated by “like” edge 906 between the user and concept node 904. In particular embodiments, social networking system 802 may store an edge 906 in one or more data stores. In particular embodiments, an edge 906 may be automatically formed by social networking system 802 in response to a particular user action. As an example, and not by way of limitation, if a first user uploads a picture, watches a movie, or listens to a song, an edge 906 may be formed between user node 902 corresponding to the first user and concept nodes 904 corresponding to those concepts. Although this disclosure describes forming particular edges 906 in particular manners, this disclosure contemplates forming any suitable edges 906 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition, or as an alternative, an advertisement may be one or more sponsored stories (e.g., a news-feed or ticker item on social networking system 802). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example, and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition, or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social networking system 802 may execute or modify a particular action of the user.

An advertisement may also include social-networking-system functionality that a user may interact with. As an example, and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social networking system 802) or RSVP (e.g., through social networking system 802) to an event associated with the advertisement. In addition, or as an alternative, an advertisement may include social-networking-system context directed to the user. As an example, and not by way of limitation, an advertisement may display information about a friend of the user within social networking system 802 who has taken an action associated with the subject matter of the advertisement.

In particular embodiments, social networking system 802 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof Affinity may also be determined with respect to objects associated with third-party systems or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social networking system 802 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social networking system 802 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example, and not by way of limitation, particular user actions may be assigned both a rating and a weight while a relationship associated with the particular user action is assigned a rating and a correlating weight (e.g., so the weights total 250%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social networking system 802 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example, and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social networking system 802 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social networking system 802 may calculate a coefficient based on a user's actions. Social networking system 802 may monitor such actions on the online social network, on a third-party system 808, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, social networking system 802 may calculate a coefficient based on the user's actions with particular types of content. The content may be associated with the online social network, a third-party system 808, or another suitable system. The content may include users, profile pages, posts, news stories, headlines, instant messages, chat room conversations, emails, advertisements, pictures, video, music, other suitable objects, or any combination thereof. Social networking system 802 may analyze a user's actions to determine whether one or more of the actions indicate an affinity for subject matter, content, other users, and so forth. As an example, and not by way of limitation, if a user may make frequently posts content related to “coffee” or variants thereof, social networking system 802 may determine the user has a high coefficient with respect to the concept “coffee.” Particular actions or types of actions may be assigned a higher weight and/or rating than other actions, which may affect the overall calculated coefficient. As an example, and not by way of limitation, if a first user emails a second user, the weight or the rating for the action may be higher than if the first user simply views the user-profile page for the second user.

In particular embodiments, social networking system 802 may calculate a coefficient based on the type of relationship between particular objects. Referencing the social graph 900, social networking system 802 may analyze the number and/or type of edges 906 connecting particular user nodes 902 and concept nodes 904 when calculating a coefficient. As an example, and not by way of limitation, user nodes 902 that are connected by a spouse-type edge (representing that the two users are married) may be assigned a higher coefficient than a user nodes 902 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example, and not by way of limitation, if a user is tagged in first photo, but merely likes a second photo, social networking system 802 may determine that the user has a higher coefficient with respect to the first photo than the second photo because having a tagged-in-type relationship with content may be assigned a higher weight and/or rating than having a like-type relationship with content. In particular embodiments, social networking system 802 may calculate a coefficient for a first user based on the relationship one or more second users have with a particular object. In other words, the connections and coefficients other users have with an object may affect the first user's coefficient for the object. As an example, and not by way of limitation, if a first user is connected to or has a high coefficient for one or more second users, and those second users are connected to or have a high coefficient for a particular object, social networking system 802 may determine that the first user should also have a relatively high coefficient for the particular object. In particular embodiments, the coefficient may be based on the degree of separation between particular objects. Degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.” The lower coefficient may represent the decreasing likelihood that the first user will share an interest in content objects of the user that is indirectly connected to the first user in the social graph 900. As an example, and not by way of limitation, social-graph entities that are closer in the social graph 900 (i.e., fewer degrees of separation) may have a higher coefficient than entities that are further apart in the social graph 900.

In particular embodiments, social networking system 802 may calculate a coefficient based on location information. Objects that are geographically closer to each other may be considered to be more related, or of more interest, to each other than more distant objects. In particular embodiments, the coefficient of a user towards a particular object may be based on the proximity of the object's location to a current location associated with the user (or the location of a client device 806 of the user). A first user may be more interested in other users or concepts that are closer to the first user. As an example, and not by way of limitation, if a user is one mile from an airport and two miles from a gas station, social networking system 802 may determine that the user has a higher coefficient for the airport than the gas station based on the proximity of the airport to the user.

In particular embodiments, social networking system 802 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social networking system 802 may provide information that is relevant to user's interests and current circumstances, increasing the likelihood that they will find such information of interest. In particular embodiments, social networking system 802 may generate content based on coefficient information. Content objects may be provided or selected based on coefficients specific to a user. As an example, and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social networking system 802 may generate search results based on coefficient information. Search results for a particular user may be scored or ranked based on the coefficient associated with the search results with respect to the querying user. As an example, and not by way of limitation, search results corresponding to objects with higher coefficients may be ranked higher on a search-results page than results corresponding to objects having lower coefficients.

In particular embodiments, social networking system 802 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 808 (e.g., via an API or other communication channel), or from another suitable system. In response to the request, social networking system 802 may calculate the coefficient (or access the coefficient information if it has previously been calculated and stored). In particular embodiments, social networking system 802 may measure an affinity with respect to a particular process. Different processes (both internal and external to the online social network) may request a coefficient for a particular object or set of objects. Social networking system 802 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503093, filed Aug. 8, 2006, U.S. patent application Ser. No. 12/977027, filed Dec. 22, 2010, U.S. patent application Ser. No. 12/978265, filed Dec. 23, 2010, and U.S. patent application Ser. No. 13/632869, field Oct. 1, 2012, each of which is incorporated by reference in their entirety.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example, and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example, and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example, and not by way of limitation, a particular concept node 904 corresponding to a particular photo may have a privacy setting specifying that the photo may only be accessed by users tagged in the photo and their friends. In particular embodiments, privacy settings may allow users to opt in or opt out of having their actions logged by social networking system 802 or shared with other systems (e.g., third-party system 808). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, social networking system 802 may send a request to the data store for the object. The request may identify the user associated with the request and may only be sent to the user (or a client device 806 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

I claim:

1. A method comprising:
configuring, by a networking system, a digital forum for a jurisdiction that allows users of the networking system to provide feedback for civic issues associated with the jurisdiction;
identifying a proposed law for the jurisdiction;
identifying, based on social networking data, a plurality of users of the networking system having a predicted interest in the proposed law;
providing, to the identified plurality of users via the digital forum for the jurisdiction, a discussion interface comprising the proposed law;
monitoring and aggregating feedback for the proposed law from the plurality of users within the discussion interface to generate a formalized proposal based on the proposed law; and
providing, to the plurality of users via the digital forum, the formalized proposal.

2. The method of claim 1, wherein identifying the proposed law comprises receiving, from a user associated with the jurisdiction, a proposed change to an existing law for the jurisdiction.

3. The method of claim 1, wherein identifying the plurality of users having a predicted interest in the proposed law comprises identifying, based on the social networking data, users of the networking system that live within a geographic boundary associated with the jurisdiction.

4. The method of claim 3, wherein identifying the plurality of users having a predicted interest in the proposed law further comprises identifying, based on the social networking data, one or more users of the networking system having reputation scores that exceed a threshold reputation score for a topic of the proposed law.

5. The method of claim 1, wherein monitoring and aggregating feedback for the proposed law comprises aggregating user ratings, comments, and one or more proposed edits to the proposed law from the plurality of users within the discussion interface.

6. The method of claim 1, further comprising adding the proposed law and the formalized proposal to a block chain associated with an existing law of the jurisdiction stored within a legal repository accessible to the networking system.

7. The method of claim 6, wherein adding the proposed law and the formalized proposal to the block chain comprising adding the proposed law and the formalized proposal to the block chain in response to detecting that a threshold number of the plurality of users has approved the formalized proposal.

8. The method of claim 1, further comprising:
identifying one or more similar laws to the proposed law from other jurisdictions;
providing, via the digital forum, the one or more similar laws and associated feedback from users of the networking system with regard to the one or more similar laws.

9. The method of claim 1, wherein monitoring and aggregating feedback to the proposed law comprises prioritizing feedback from the plurality of users based on reputation scores associated with the plurality of users.

10. The method of claim 9, wherein the reputation scores comprises topic-specific reputation scores based on determined reputations for the plurality of users corresponding to a topic of the proposed law.

11. The method of claim 9, wherein monitoring and aggregating feedback to the proposed law further comprises prioritizing feedback from users of the plurality of users that live within the geographic boundary of the jurisdiction.

12. The method of claim 1, wherein configuring the digital forum comprises providing a plurality of discussion interfaces for a plurality of existing laws of the jurisdiction, the plurality of discussion interfaces comprising at least one discussion interface for each of the plurality of existing laws.

13. A system comprising:
at least one processor;
at least one non-transitory computer readable storage medium storing instructions that, when executed by the at least one processor, cause the system to:
configure, by a networking system, a digital forum for a jurisdiction that allows users of the networking system to provide feedback for civic issues associated with the jurisdiction;
identify a proposed law for the jurisdiction;
identify, based on social networking data, a plurality of users of the networking system having a predicted interest in the proposed law;
provide, to the identified plurality of users via the digital forum for the jurisdiction, a discussion interface comprising the proposed law;
monitor and aggregate feedback for the proposed law from the plurality of users within the discussion interface to generate a formalized proposal based on the proposed law; and
provide, to the plurality of users via the digital forum, the formalized proposal.

14. The system of claim 13, wherein identifying the proposed law comprises receiving, from a user associated with the jurisdiction, a proposed change to an existing law for the jurisdiction.

15. The system of claim 13, wherein monitoring and aggregating feedback for the proposed law comprises adding the proposed law and the formalized proposal to a block chain associated with an existing law of the jurisdiction stored within a legal repository accessible to the networking system in response to detecting that a threshold number of the plurality of users has approved the formalized proposal.

16. The system of claim 13, wherein monitoring and aggregating feedback to the proposed law comprises prioritizing feedback from the plurality of users based on reputation scores associated with the plurality of users.

17. A non-transitory computer readable medium storing instructions thereon that, when executed by at least one processor, cause a computer system to:
configure, by a networking system, a digital forum for a jurisdiction that allows users of the networking system to provide feedback for civic issues associated with the jurisdiction;
identify a proposed law for the jurisdiction;
identify, based on social networking data, a plurality of users of the networking system having a predicted interest in the proposed law;
provide, to the identified plurality of users via the digital forum for the jurisdiction, a discussion interface comprising the proposed law;
monitor and aggregate feedback for the proposed law from the plurality of users within the discussion interface to generate a formalized proposal based on the proposed law; and
provide, to the plurality of users via the digital forum, the formalized proposal.

18. The non-transitory computer readable storage medium of claim 17, wherein identifying the proposed law comprises receiving, from a user associated with the jurisdiction, a proposed change to an existing law for the jurisdiction.

19. The non-transitory computer readable storage medium of claim 17, wherein monitoring and aggregating feedback for the proposed law comprises adding the proposed law and the formalized proposal to a block chain associated with an existing law of the jurisdiction stored within a legal repository accessible to the networking system in response to detecting that a threshold number of the plurality of users has approved the formalized proposal.

20. The non-transitory computer readable storage medium of claim 17, wherein monitoring and aggregating feedback to the proposed law comprises prioritizing feedback from the plurality of users based on reputation scores associated with the plurality of users.
